(19) United States
(12) Patent Application Publication
(10) Pub. No.: US 2007/0165647 A1
(43) Pub. Date: Jul. 19, 2007

(54) Apparatus, method, and computer program for data packet scheduling

(75) Inventors: John Belden Kenney, Granger, IN (US); James Daniel Mills, Wilmington, MA (US)

Correspondence Address: FITZPATRICK CELLA HARPER & SCINTO, 30 ROCKEFELLER PLAZA, NEW YORK, NY, 10112, US

(73) Assignee: TELLABS OPERATIONS, INC., Naperville, IL (US)

(21) Appl. No.: 11/334,594

(22) Filed: Jan. 19, 2006

(51) Int. Cl. H04L 12/56; H04L 12/28

(52) U.S. Cl. 370/395.4; 370/395.43; 370/412

(57) ABSTRACT

An apparatus, method, and computer program for data packet scheduling in a system having a plurality of queues including a mixed queue are provided. The mixed queue has first traffic associated with a bandwidth guarantee and second traffic associated with a best effort expectation of access to available bandwidth. A first weight is assigned for the first traffic and a second weight is assigned for the second traffic. Information about the first traffic is tracked. The first traffic is served based on the first information such that the first traffic is provided the guaranteed bandwidth and the second traffic is served in proportion to the second weight.

### BACKGROUND OF THE INVENTION

1. Field of the Invention

This invention pertains to devices, methods, and computer programs of data packet scheduling. Specifically, the invention relates to a scheduler system in which at least one data traffic queue carries traffic from flows with both a bandwidth guarantee and an expectation of fair access to available bandwidth for excess traffic.

2. Related Background Art

As society's reliance on digital packet data transfer continues to grow, efficient and fair scheduling of data traffic from multiple sources becomes increasingly important. Data packet schedulers can be used, for example, to multiplex data traffic from different sources onto one data link. Traditional data packet schedulers use a variety of methods to allocate the limited bandwidth of the link (link bandwidth) among the multiple sources (as used herein, bandwidth is a rate of data flow measured in bits per second or equivalent). For example, in many packet network environments each source of data is associated with a particular service class and a corresponding data traffic queue. A source that is in a dedicated bandwidth (DB) class is promised access to some quantity of link bandwidth. Traffic from the source is policed to the guaranteed rate and is enqueued in the DB queue. The scheduler serves the data traffic in the DB queue onto the link to meet the promised quantity of bandwidth, the DB guarantee.

A source associated with a mixed guaranteed/best effort (G+E) class receives a bandwidth commitment, the G guarantee, but unlike the DB class it is not policed to that rate. Rather, some quantity of excess traffic in the G+E queue above the minimum rate is allowed, within limits of some traffic model. Thus, some portion of traffic in the G+E queue, the bandwidth guarantee portion, is served to meet the G guarantee; while the remaining portion of traffic in the G+E queue, the best effort portion, has an expectation of fair access to available bandwidth (i.e., no bandwidth commitment is made to this traffic). The available bandwidth is the portion of link bandwidth unused by the guaranteed bandwidth traffic (for example, the traffic in the DB queue and the bandwidth guarantee traffic of the G+E queue) of the system. A source in a pure best effort (BE) class is given no quality of service promise. Like the best effort portion of the G+E traffic, the traffic in a BE queue is allowed access to the available bandwidth only.

One of the drawbacks of known data packet scheduling systems is lack of fairness in allocating available bandwidth among the best effort portions of multiple queues, for example, among the BE queues and best effort portions of the G+E queues. In particular, known systems lack the ability to maintain a constant and predetermined ratio of allocation of available bandwidth among the best effort portions of the multiple queues when at least one of the queues is a mixed queue.

By way of example, consider a traditional Weighted Round Robin (WRR) serving fixed-length data packets (cells) from three queues. The first queue is a DB queue for traffic that has a bandwidth commitment and no best effort component. Cells in the DB queue are “DB cells,” or simply, “DB traffic.” The second queue is a mixed queue for traffic that has both a bandwidth commitment and a best effort component. Cells in the mixed queue that are associated with the bandwidth commitment are “G cells,” or simply, “G traffic.” Cells in the mixed queue that are associated with the best effort component are “E cells,” or simply, “E traffic.” Thus, the mixed queue is also known as the G+E queue. The third queue is a BE queue for traffic that has no bandwidth commitment. Cells in the BE queue are “BE cells,” or simply, “BE traffic.”

In this example of a traditional WRR, the bandwidth commitments associated with the DB queue and the G+E queue are met by weighting the queues. For example, the traditional WRR has a list of scheduling slots, with each slot assigned to a particular queue. In traditional WRR, the weight of a queue is manifested in the fraction of slots in the list assigned to that queue. A higher weight corresponds to a higher fraction of slots, which in turn means a higher rate of scheduling opportunities for the queue.

In a traditional scheduler, a scheduling opportunity is a moment in time, usually when the cell or packet in service completes its service, that the scheduler must decide which cell or packet to service next, for example, which Head Of Line (HOL) packet to service next. Furthermore, a scheduling opportunity for queue X is a scheduling opportunity in which queue X possesses the winning characteristic for this opportunity, e.g. for traditional WRR or traditional Deficit Round Robin (DRR), discussed below, it means the list pointer is pointing to a slot assigned to queue X, or for traditional Start-Time Fair Queuing (SFQ), discussed below, it means the packet with minimum start time is stored in queue X.

In one formulation of WRR, during one round of service each slot assigned to a queue serves one cell of data from the queue. The weight of a queue equals the number of slots on the WRR list assigned to the queue divided by the total number of slots in the WRR list (i.e., the total number of slots assigned to all queues in the system). The weight of a queue determines the proportion of the link bandwidth reserved for the queue.

The DB queue and the G+E queue are weighted to meet the bandwidth commitments made to their respective sources by, for example, assigning a sufficient number of slots to each queue to meet the bandwidth commitment for the queue. For example, if a set of G+E sources that share a G+E queue are collectively promised access to 20% of the link bandwidth, then the scheduler assigns a number of slots to that G+E queue at least equal to 20% of the total number of slots on the WRR list. Once slots are assigned to the queues having a bandwidth commitment, the BE queue is assigned the remaining slots. This assignment of slots is typical.

In this traditional WRR, when all DB slots are used to serve DB cells and all G+E slots are used to serve G cells, the remaining bandwidth is allocated to BE traffic only. On the other hand, if some of the bandwidth reserved for the DB queue is unused by DB traffic, this unused bandwidth is allocated between E traffic and BE traffic in proportion to the weights of the G+E queue and BE queue, respectively. Finally, if some of the bandwidth reserved for the guaranteed bandwidth portion of the G+E traffic is unused by G traffic, that bandwidth is allocated to the E traffic. Note that it is possible for the G+E queue to have E cells even while the amount of traffic that qualifies for the G+E bandwidth guarantee is less than the amount of guaranteed bandwidth, for example, if the G+E queue serves multiple sources or if the service eligibility of cells is explicitly marked.

As discussed above, this traditional WRR does not maintain a predetermined desired ratio of available bandwidth allocation between E traffic and BE traffic. Rather, the ratio of available bandwidth allocation between the E traffic and BE traffic in a traditional WRR varies as the DB traffic and the G traffic varies. As an illustrative example, consider the traditional WRR discussed above multiplexing traffic from one DB queue, one G+E queue, and one BE queue onto a link, in which the DB queue is promised access to 20% of link bandwidth and the G+E queue is promised access to 30% of link bandwidth. The proportion of slots assigned to each queue to the total number of slots is 20% for the DB queue, 30% for the G+E queue, and 50% for the BE queue. FIG. 10A illustrates how available bandwidth (the amount of link bandwidth not being consumed by DB traffic and G traffic) is allocated to E and BE traffic as actual DB and G demand varies over time. In FIG. 10A, the bandwidths consumed by DB traffic and G traffic are labeled “DB use” and “G use,” respectively, and the available bandwidth is shown as the top two bands (labeled “BE alloc” for the portion allocated to BE traffic and “E alloc” for the portion allocated to E traffic). In FIG. 10A, E traffic receives between 0% and 24% of available bandwidth, with BE traffic receiving the remaining available bandwidth, at any given time.

In another example, FIG. 10B shows how available bandwidth is allocated to E and BE traffic in the traditional WRR described above in which the DB queue is promised access to 30% of link bandwidth and the G+E queue is promised access to 50% of link bandwidth. The proportion of slots assigned to each queue to the total number of slots is 30% for the DB queue, 50% for the G+E queue, and 20% for the BE queue. FIG. 10B shows that E traffic receives between 0% and 71% of available bandwidth, with BE traffic receiving the remaining available bandwidth, at any given time.

As illustrated above, the ratio of the available bandwidth received by the E traffic to the available bandwidth received by the BE traffic varies as actual DB and G demands vary. Therefore, a traditional WRR does not allow a user to maintain a desired bandwidth ratio of best effort portions of the multiple queues, i.e., to maintain a constant ratio of allocated available bandwidths over time, regardless of the actual bandwidth demand of the guaranteed bandwidth portions.

Similarly, a traditional Deficit Round Robin (DRR) does not allow for a desired bandwidth ratio of the best effort portions. One such DRR is described in “Efficient Fair Queuing using Deficit Round Robin,” M. Shreedhar and George Varghese, Proceedings Sigcomm '95, Cambridge, Mass., pp. 231-242, 1995, the content of which is incorporated by reference herein in its entirety. A DRR associates a slot in the list not with the service of one packet or one cell, but with a quantum of service credit (typically in units of bytes or bits). The queue associated with the slot is allowed to serve as many complete packets as it has credit. Service for a slot ends when the residual credit is less than the length of the HOL packet, or when the queue becomes inactive (empty). When service for a slot is complete, the residual credit is remembered as state information for that queue. If the queue is inactive, the residual credit is reset to zero. When the scheduler reaches that queue's next slot in the DRR list, the residual credit is added to the credit quantum, and again the maximum number (possibly zero) of complete packets are served such that the credit is strictly non-negative.

In traditional DRR, the weight of a queue is manifested in the fraction of the service credit of the list that is assigned to that queue. The service credit of the queue is the product of the number of slots assigned to the queue and the service quantum associated with each slot, and the service credit of the list is the sum of the service credits of all the queues. A higher weight corresponds to a higher fraction of service credit, which in turn means a higher rate of scheduling opportunities for the queue.

In traditional DRR, allocation of bandwidth is accomplished by assigning different quanta of service credit to different queues, or by assigning different numbers of slots to different queues, or by some combination of both. As with a traditional WRR, a traditional DRR does not maintain a predetermined desired ratio of bandwidth allocation between E traffic and BE traffic. Therefore, a traditional DRR does not allow a user to maintain a desired bandwidth ratio of best effort portions of the multiple queues.

Similarly, a Combined DRR and Rate Wheel scheduler does not allow for a desired bandwidth ratio of the best effort portions. One such Combined DRR and Rate Wheel scheduler is described in U.S. Patent Application Pub. No. 2002/0110134 A1, the content of which is incorporated by reference herein in its entirety. A rate wheel is a type of scheduler that provides scheduling opportunities to a queue at regular intervals according to a configured rate. A rate wheel assigns a scheduling opportunity to a queue X if the rate wheel associates the current time with queue X and if queue X is active. If the rate wheel associates the current time with an inactive queue, or does not associate the current time with any queue, then the rate wheel does not assign the scheduling opportunity to any queue.

In a Combined DRR and Rate Wheel scheduler, the rate wheel has priority over the DRR. When a scheduling opportunity arises, the rate wheel assigns the scheduling opportunity if the rate wheel associates the current time with an active queue. Otherwise, the DRR assigns the scheduling opportunity to an active queue, if any, in the DRR list. At times when a packet is served from the rate wheel the DRR pointer does not advance. In a Combined DRR and Rate Wheel scheduler, a given queue may be served via a configured rate on the rate wheel, or via slots in the DRR list, or both. The G+E queue may be supported in a Combined DRR and Rate Wheel scheduler by configuring the rate wheel with a rate sufficient to meet the bandwidth commitment of the G+E queue and by assigning slots in the DRR list to the G+E queue to provide additional access to bandwidth. The BE queue is also assigned slots in the DRR list. If the Combined DRR and Rate Wheel scheduler serves G traffic at a rate less than the rate configured on the rate wheel for the G+E queue, the resulting available bandwidth is allocated entirely to E traffic. Other available bandwidth in the combined DRR and rate wheel scheduler is allocated between E traffic and BE traffic in proportion to the weights of the G+E queue and the BE queue in the DRR, respectively. Therefore, the Combined DRR and Rate Wheel scheduler does not maintain a predetermined desired ratio of available bandwidth allocation between E traffic and BE traffic.

Similarly, a traditional Weighted-Fair Queue (WFQ) and variants of WFQ, such as Start-time Fair Queuing (SFQ), do not allow for a desired bandwidth ratio of the best effort portions. One such SFQ is described in “Start-Time Fair Queuing: A Scheduling Algorithm for Integrated Services Packet Switching Networks,” Pawan Goyal, Harrick M. Vin, and Haichen Cheng, Proceedings Sigcomm '96, the content of which is incorporated by reference herein in its entirety. In SFQ, when a new packet is enqueued, its Start Time (ST) is computed as the maximum of the Finish Time (FT) of the immediately preceding packet in the same queue and the ST of the packet currently in service. The packet currently in service need not be in the same queue as the new packet. Once the ST of the new packet is computed, the FT of the new packet is computed by adding the length of the packet divided by a weight assigned to the queue. When one packet completes service, the SFQ scheduler begins serving the queued packet with the minimum ST.

In traditional SFQ, the weight of a queue is manifested in a mathematical formula that is used to compute a scheduling index (the start time); the higher the weight, the lower the index, which in turn means a higher rate of scheduling opportunities for the queue.

As with a traditional WRR and DRR, a traditional SFQ does not maintain a predetermined desired ratio of bandwidth allocation between E traffic and BE traffic. Therefore, a traditional SFQ does not allow a user to maintain a desired bandwidth ratio of best effort portions of the multiple queues.

### SUMMARY OF INVENTION

To address the foregoing, the present invention provides a method, apparatus, and computer program of data packet scheduling. The invention allows the support of independent bandwidth and fairness objectives within a single service. Using the invention, for example, a service provider can offer enhanced services to end-users and also control bandwidth allocation more flexibly for traffic engineering purposes. The invention can be used in a wide variety of applications such as servers, routers, switches, aggregators, multiplexers, and other applications that utilize data services. Some potential areas of use include packet networks that support queues of mixed type, including internet service, virtual private networks (VPNs), and private networks, particularly when fairness in bandwidth distribution is a design goal.

In accordance with an exemplary embodiment of the present invention, a method, apparatus and computer program for data packet scheduling in a system having a plurality of queues including a mixed queue are provided. The mixed queue has at least first traffic associated with a bandwidth guarantee and second traffic associated with a best effort expectation of access to available bandwidth. A first weight is assigned for the first traffic and a second weight is assigned for the second traffic. First information about the first traffic is tracked. The first traffic is served based on the first information, such that the first traffic is provided the guaranteed bandwidth and the second traffic is served in proportion to the second weight.

The tracking preferably emulates separate queuing of the first traffic, according to one embodiment of the invention.

In at least one embodiment of the invention, the mixed traffic is served when a scheduling opportunity associated with the first traffic occurs. The proportion of scheduling opportunities associated with the first traffic is based on the first information and the first weight.

According to one embodiment of the invention, the first traffic includes first packets associated with a first packet value, and tracking includes at least one of adding the first packet value to the first information when a first packet is enqueued in the mixed queue and subtracting the first packet value from the first information when a scheduling opportunity associated with the first traffic is used to serve the mixed traffic.

In another embodiment of the invention, serving includes comparing the first information with a scheduling criterion and prohibiting a scheduling opportunity associated with the first traffic based on a result of the comparison.

In another embodiment, assigning a first weight includes assigning a number of first slots. Tracking includes incrementing a counter when a first packet is enqueued in the mixed queue and decrementing the counter when a scheduling opportunity associated with the first traffic is used to serve the mixed traffic. A scheduling opportunity associated with the first traffic occurs when at least a first slot is selected and the counter is non-zero. The first slot is skipped when the counter is zero.

In another embodiment of this invention, assigning a first weight includes assigning a number of first slots and a first quantum of service credit. Tracking includes increasing a counter by a packet length of a first packet enqueued in the mixed queue and decreasing the counter by a packet length of a packet served from the mixed traffic when a scheduling opportunity associated with the first traffic is used to serve the mixed traffic. A scheduling opportunity associated with the first traffic occurs when at least a first slot is selected and a packet length of a head-of-line packet of the mixed queue is less than or equal to the counter. A next slot is selected when the counter is less than the packet length of the head-of-line packet of the mixed queue.

In another embodiment, assigning a first weight includes assigning a first weight value. Tracking includes appending a packet time of a first packet enqueued in the mixed queue to a packet time list and removing the packet time from the packet time list when the packet time is used to serve a packet from the mixed queue. A scheduling opportunity associated with the first traffic occurs when at least the packet time list contains a minimum packet time. A different packet time list is selected when the packet time list does not contain the minimum packet time.

In another aspect of this invention, packet times of the second traffic are tracked. The packet times of the first traffic and the packet times of the second traffic can be recorded in the same list or in different lists.

In another aspect, the packet times are start times. The start time of a first packet is based on the greater of a finish time of a preceding first packet and the start time of a packet currently being served. The finish time of the preceding first packet is based on the start time of the preceding first packet, a packet length of the preceding first packet, and the first weight. The start time of a second packet is based on the greater of the finish time of a preceding second packet and the start time of the packet currently being served. The finish time of the preceding second packet is based on the start time of the preceding second packet, the packet length of the preceding second packet, and the second weight.

In another embodiment of this invention, the plurality of queues includes an additional queue having at least third traffic associated with a best effort expectation of access to available bandwidth. A third weight is assigned for the third traffic. The ratio of the second weight to the third weight is in a desired ratio of allocation of available bandwidth between the second traffic and the third traffic.

In another embodiment, traffic entering the mixed queue is classified as either first traffic or second traffic.

The invention may be embodied in, without limitation, a method, apparatus, or computer-executable program instructions.

This brief summary has been provided so that the nature of the invention may be understood quickly. A more complete understanding of the invention can be obtained by reference to the following detailed description in connection with the attached drawings.

### BRIEF DESCRIPTION OF THE DRAWINGS

FIG. 1 is a block diagram of an exemplary environment in which an embodiment of the present invention can be implemented.

FIG. 2 is a block diagram of a system for scheduling fixed-length cells according to one embodiment of the present invention.

FIGS. 3A and FIG. 3B are process flowcharts of a method for serving fixed-length cells according to one embodiment of the present invention.

FIGS. 4A and 4B are graphs depicting allocation of bandwidth in one embodiment of the present invention.

FIG. 5 is a block diagram of a system for scheduling variable-length packets according to one embodiment of the present invention.

FIGS. 6A to 6C are process flowcharts of a method for serving variable-length packets according to one embodiment of the present invention.

FIG. 7 is a process flowchart of a method for serving packets using a start time fair queuing-type method according to one embodiment of the present invention.

FIG. 8 is a block diagram of a system including a Leaky Bucket policer according to one embodiment of the present invention.

FIG. 9 is an architecture diagram of a data processing system in accordance with an exemplary embodiment of the present invention.

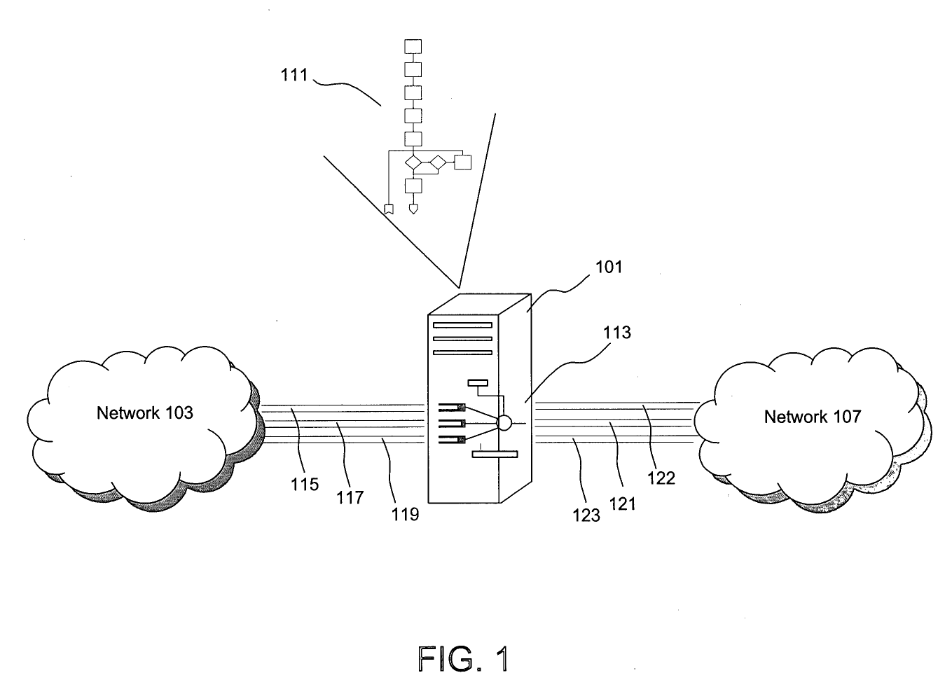

FIGS. 1OA and 10B are graphs depicting allocation of bandwidth in a traditional WRR system.

### DETAILED DESCRIPTION

Embodiments of the present invention are described below with reference to the accompanying drawings. The embodiments describe an apparatus, method, and computer program of data packet scheduling that enable the maintenance of a predetermined desired ratio of available bandwidth allocation among the best effort portions of mixed queue and pure best effort traffic.

As discussed above, traditional data packet schedulers assign a weight to each queue, including the G+E queue. For example, a traditional WRR scheduler assigns a number of slots to the G+E queue to serve packets in the G+E queue. However, the weight assigned to the G+E queue is associated with all G+E queue traffic, regardless of the fact that the G+E queue contains traffic associated with a guaranteed bandwidth commitment and traffic associated with a best effort expectation of access to available bandwidth. In other words, traditional schedulers do not separately weight the guaranteed bandwidth portion and the best effort portion of a mixed queue, rather, the entire mixed queue is weighted with one weight. While a traditional scheduler can individually weight the pure best effort queues (for example, queues in the BE class), traditional schedulers lack the ability to allocate available bandwidth to all best effort portions in a predetermined desired ratio because the best effort portions of the mixed queues are not individually weighted.

In addition, even if traditional schedulers were modified to assign individual weights to the guaranteed bandwidth portion and the best effort portion of a mixed queue, for example, by assigning separate G slots and E slots in a WRR scheduler, an additional problem remains. Specifically, and further using WRR as an example, some G slots would end up serving E traffic, and some E slots would end up serving G traffic. This results in part because G traffic associated with the guaranteed bandwidth portion and E traffic associated with the best effort portion are physically queued together because of ordering constraints. Therefore, without a method to balance the use of G slots to serve E traffic with the use of E slots to serve G traffic, the actual proportions of G traffic and E traffic served would vary from the assigned weights of the G traffic and E traffic. Accordingly, a predetermined desired ratio of allocation of available bandwidth among the best effort portions of the system could not be maintained.

As the embodiments of the present invention described below illustrate, the present invention addresses the foregoing and allows maintenance of a predetermined desired ratio of allocation of available bandwidth among the best effort portions.

FIG. 1 depicts one exemplary environment in which an embodiment of the present invention can be implemented. For example, server 101 stores operating instructions 111 according to an embodiment of the present invention described below. Server 101 includes a scheduler 113 in accordance with an embodiment of the present invention described below.

Network 103 transmits flows of data to server 101. For example, the flows of data include a dedicated bandwidth flow 115, a mixed-bandwidth flow 117 (which includes a bandwidth guarantee flow and a best effort flow, not shown), and a best effort flow 119. Server 101 schedules the flows of data, 115, 117, and 119, using scheduler 113 to serve packets of data from the flows of data in accordance with operating instructions 111, and outputs the served packets as a set of three transmitted flows of data, 121, 122, and 123 to Network 107.

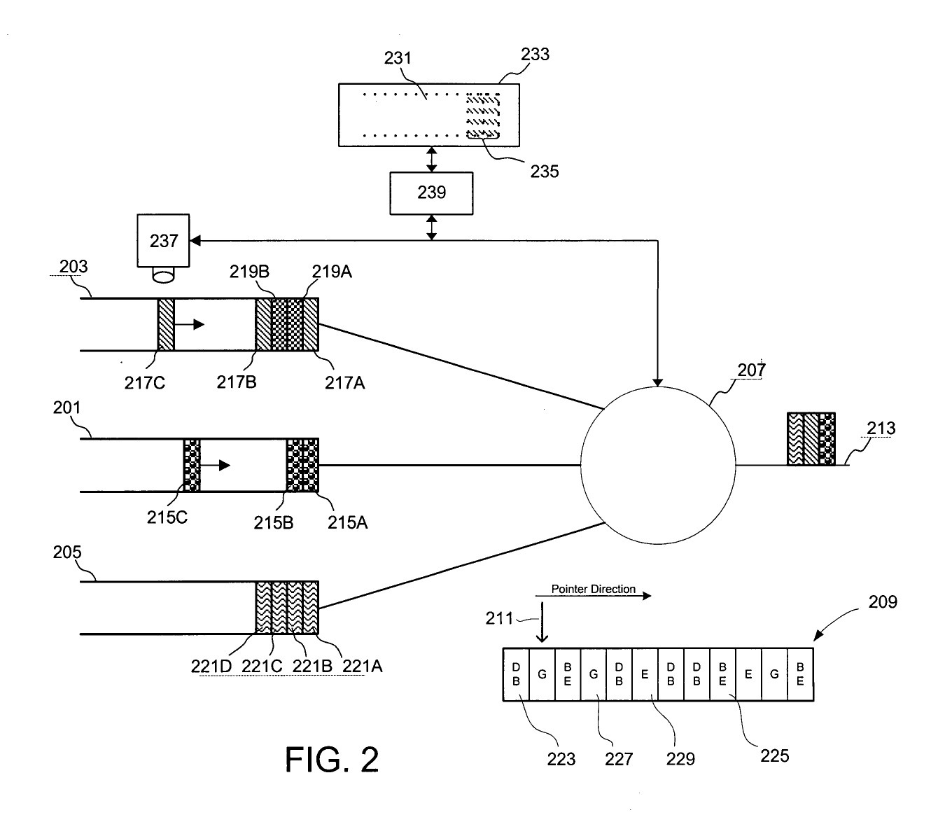

In one embodiment of the present invention, the invention is applied to a WRR scheduler serving fixed length cells in three class-queues, although in other embodiments other types of schedulers also can be used. In contrast to a traditional WRR scheduler, the present embodiment allows available bandwidth to be allocated to the best effort flows in a predetermined desired ratio that is maintained even though the traffic in the other flows varies. A flow is the set of all the cells or packets in a physical queue that share a traffic type designation, for example, DB, G, E, or BE. For simplicity, the following descriptions of embodiments of the present invention assume a single flow exists for each traffic type designation. However, a flow could also be termed a “scheduling class,” and each scheduling class would generally be composed of multiple flows (perhaps thousands). A general description of the present embodiment is provided below with reference to FIG. 2.

FIG. 2 depicts an example of one embodiment of the present invention, which includes a DB queue 201, a G+E queue 203, and a BE queue 205. Although only one of each type of physical queue is shown, it is also within the scope of the invention to use more or fewer of each type of queue, or other types of queues, as long as at least one queue is a mixed queue. In each physical queue, there are one or more flows. A DB flow is in DB queue 201, and a BE flow is in BE queue 205. In G+E queue 203 there are two flows, a G flow and an E flow. FIG. 2 shows the three physical queues multiplexed onto a link 213 by a scheduler 207, using a WRR list 209 and a pointer 211. A few cells in the queues and a few cells transmitted on the link are also shown. While the invention can be used with, for example, variable length packets (or frames) or fixed length cells, the illustrated embodiment utilizes cells.

As a DB cell 215C arrives at DB queue 201, DB cell 215C is enqueued sequentially based on arrival time behind earlier arriving DB cells 215A and 215B. The cell in DB queue 201 with the earliest arrival time, DB cell 215A, is at the head-of-line (HOL). Similarly, as a G cell 217C arrives at G+E queue 203, G cell 217C is enqueued sequentially behind earlier arriving G cells 217A and 217B and earlier arriving E cells 219A and 219B. As shown in FIG. 2, G cell 217A is currently the HOL cell of G+E queue 203. Finally, BE queue 205, which currently contains BE cells 221A, 221B, 221C, and 221D, is utilized in a corresponding fashion.

The flows of the system are weighted by assigning slots, shown in FIG. 2 in the WRR list 209. Specifically, scheduler 207 assigns a number of G slots 227 in WRR list 209 proportional to the desired weight of the G traffic. Likewise, scheduler 207 assigns a number of E slots 229 in WRR list 209 proportional to the desired weight of the E traffic. The number of G slots 227 assigned preferably is sufficient to meet the G reservation. The number of E slots 229 assigned is in a pre-selected desired ratio to the number of BE slots 225, which are associated with BE traffic, in WRR list 209. The desired ratio represents a predetermined ratio of allocation of available bandwidth among the best effort portions of the queues (the best effort flows). In this example, the E traffic and the BE traffic are the best effort portions, and the desired ratio is determined by the ratio of E slots 229 to BE slots 225. The number of E slots 229 represents the number of E cells to be served in a round of service, as described below. The number of BE slots 225 represents the number of BE cells to be served in a round of service. Therefore, the number of E slots 229 and the number of BE slots 225 can be pre-selected to provide a fair allocation of available bandwidth, i.e., in a desired ratio, which remains constant over time regardless of actual bandwidth demand of the guaranteed bandwidth portions of the system. WRR list 209 also has a number of DB slots 223, which are associated with DB traffic, sufficient to meet the DB reservation. For example, FIG. 2 shows WRR list 209 with a total of 12 slots (three G slots 227, two E slots 229, four DB slots 223, and three BE slots 225).

During the operation of the scheduler, pointer 211 advances through the slots of WRR list 209 in the direction indicated, stopping at each slot in WRR list 209. When pointer 211 reaches the end of WRR list 209, pointer 211 returns to the beginning of WRR list 209, completing one round of service. When pointer 211 reaches a slot associated with an active queue, scheduler 207 serves an HOL cell when the cell currently in service completes its service (i.e., the slot is used). In other words, when pointer 211 reaches a slot associated with an active queue and current service is completed, a scheduling opportunity for that queue occurs, and scheduler 207 serves an HOL cell based on the scheduling opportunity. As explained more fully below, scheduler 207 serves an HOL cell from a physical queue, regardless of whether the scheduling opportunity occurs for a physical queue or an emulated queue.

Specifically, when pointer 211 reaches a DB slot 223 in WRR list 209, scheduler 207 serves the HOL cell of DB queue 201, currently DB cell 215A, and pointer 211 advances to the next slot in WRR list 209. When DB cell 215A is served, the cell with the next earliest arrival time of the remaining cells in DB queue 201, here DB cell 215B, then becomes the HOL cell of DB queue 201. Assuming DB queue 201 does not become empty, in each round of service, each individual DB slot 223 in WRR list 209 results in the service of one DB cell, and the total number of DB cells served per round equals the number of DB slots 223 assigned. Therefore, service of DB cells can be controlled by assigning the number of DB slots 223.

Scheduler 207 uses BE slots 225 from BE queue 205 to serve BE cells in the same fashion, wherein for each round of service, each BE slot 225 results in the service of one BE cell, and the total number of BE cells served per round equals the number of BE slots 225 assigned. Service of BE cells thus can be controlled by assigning the number of BE slots 225.

When pointer 211 reaches a G slot 227, the HOL cell of G+E queue 203 is served, regardless of whether the HOL cell is a G cell or an E cell. The current HOL cell of G+E queue 203, as shown in FIG. 2, is G cell 217A. Likewise, when an E slot 229 is used, scheduler 207 serves the HOL cell of G+E queue 203, regardless of whether the HOL cell is an E cell or a G cell. Thus, a G slot 227 can be used to serve a G cell or an E cell, and an E slot 229 can be used to serve an E cell or a G cell.

To account for this variable usage of G slots 227 and E slots 229, and therefore provide control over the service of G cells and E cells, an Emulated G Queue (EGQ) 231 is used to track G cell information regarding what would happen if the G and E traffic were queued separately. EGQ 231 preferably is implemented as a data store in a computer-readable memory 233. EGQ 231 includes state information that tracks how full a physically separate G queue would have been, if such a queue physically existed. Specifically, EGQ 231 maintains state information regarding G cells in the form of Emulated G (EG) cells 235. A G cell detector 237 detects a G cell entering G+E queue 203, such as G cell 217C, and consequently sends a G cell detection signal (not shown) to an EGQ calculator 239. Upon receipt of the G cell detection signal, EGQ calculator 239 adds to EGQ 231 by incrementing EG cells 235 by one EG cell. When pointer 211 reaches a G slot 227 and EGQ 231 is active (EG cells 235 is greater than zero), the G slot 227 is used to serve the HOL cell of G+E queue 203 when the cell currently being served completes service. When a G slot 227 is used to serve the HOL cell of G+E queue 203, scheduler 207 sends a G slot-use signal (not shown) to EGQ calculator 239. Upon receipt of the G slot-use signal, EGQ calculator 239 subtracts from EGQ 231 by decrementing EG cells 235 by one EG cell.

In other words, EGQ 231 is associated with G slots 227 and G traffic. When pointer 211 reaches a G slot 227, EGQ 231 is active, and current service is completed, a scheduling opportunity associated with G traffic occurs. Scheduler 207 uses the scheduling opportunity associated with G traffic to serve the HOL cell of G+E queue 203, which is the physical queue of the G traffic. Thus, scheduling opportunities for the emulated queue EGQ 231 (i.e., scheduling opportunities associated with G traffic) result in service of the HOL cell of the physical queue G+E queue 203. The HOL cell of G+E queue 203 is served regardless of whether the HOL cell is an E cell or a G cell. When a scheduling opportunity associated with G traffic is used to serve the HOL cell, EGQ 231 is decremented by one EG cell as discussed above.

When pointer 211 reaches an E slot 229, G+E queue 203 is active, and current service is completed, a scheduling opportunity associated with E traffic occurs. Scheduler 207 uses the scheduling opportunity associated with E traffic to serve the HOL cell of G+E queue 203, which is the physical queue of the E traffic. The HOL cell of G+E queue 203 is served regardless of whether the HOL cell is an E cell or a G cell.

If scheduler 207 reaches a G slot 227 and finds EGQ 231 empty (number of EG cells 235 equals zero), the G slot 227 is skipped just as it would be for any slot associated with a physically empty queue. Therefore, EGQ 231 limits G slot 227 use to the number of G cells that have been enqueued in G+E queue 203. In other words, EGQ 231 ensures that the number of G cells that are enqueued (and eventually served) is equal to the number of G slots 227 used by scheduler 207 (i.e., the number of scheduling opportunities associated with G traffic used to serve an HOL cell). As a result, the number of E cells that are enqueued (and eventually served) is equal to the number of E slots 229 used by scheduler 207. Thus, the total number of G cells and E cells served will equal the number of G slots 227 and E slots 229 used, respectively.

Moreover, because service of BE cells and E cells can be individually weighted, it is possible to set a desired ratio of service of these two best effort portions of the system based on the number of assigned BE slots 225 and the number of assigned E slots 229.

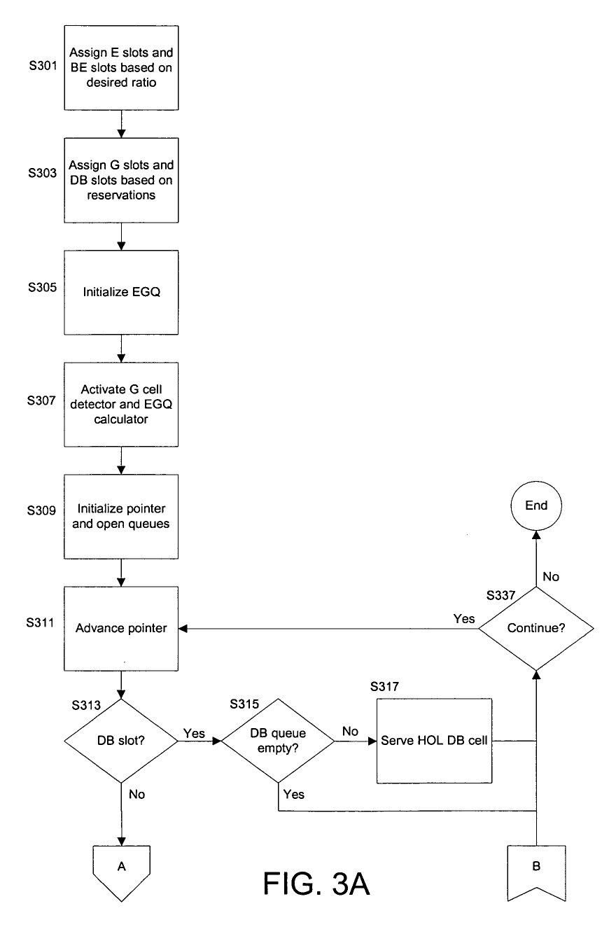

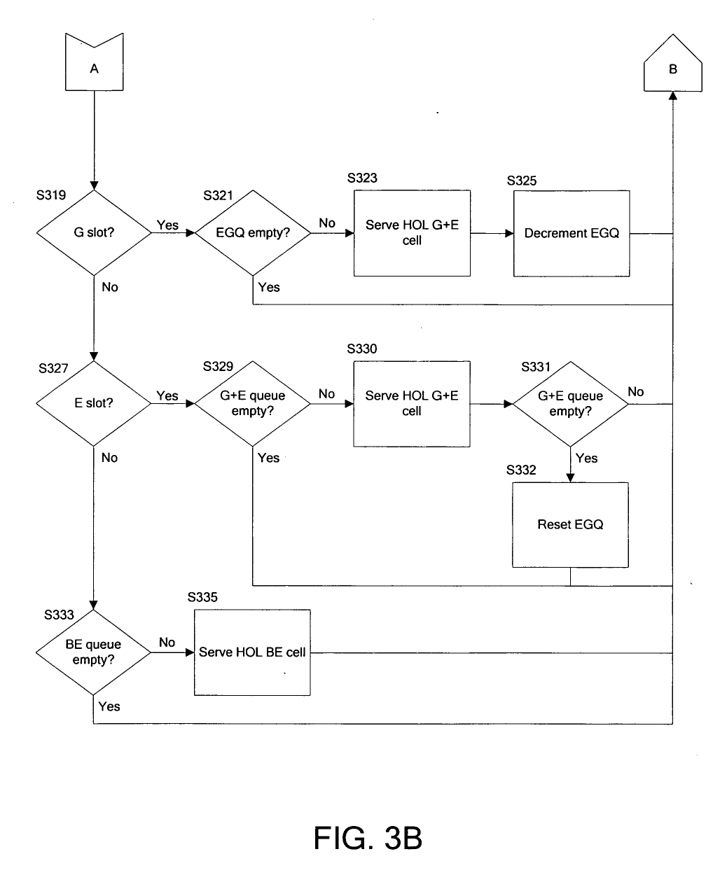

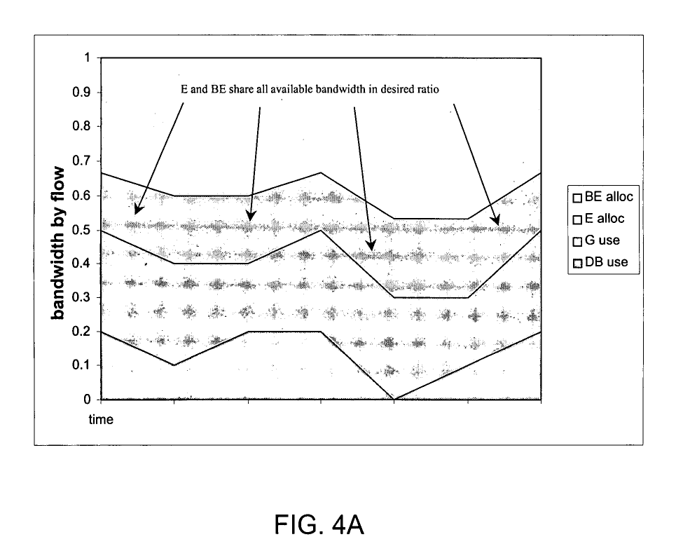

Now a more detailed description of a method of scheduling cells in accordance with the present embodiment will be described with reference to FIG. 3A, FIG. 3B, and FIG. 2. Specifically, the logic for advancing the WRR pointer and serving a cell is described. There is a tight delay constraint on the pointer advancement logic because it has to find the next active queue before it is time to transmit the first bit of the next cell, and it may have to skip over quite a few idle queues who have slots in front of the slot associated with the next active queue. The search for the next active queue should not allow any bandwidth to be wasted. For the purpose of illustration, pointer advancement and cell service are shown operating serially. However, a common approach is to perform the pointer advancement and cell service functions in parallel. In that approach, when a cell begins service (i.e. transmission), the pointer advances to the next slot and checks whether the associated queue is active. It continues advancing until it locates the next active queue in the list. That way, when the cell completes its service, the pointer is already pointing at the next cell to be served.

Turning to FIG. 3A, in S301 and S303 slots are assigned in proportion to the weight of each flow. In particular, a number of E slots 229 and a number of BE slots 225 are assigned (S301) in WRR list 209 by scheduler 207 in proportion to a predetermined desired bandwidth allocation ratio between E traffic and BE traffic. In FIG. 2, for example, the desired ratio of E traffic to BE traffic is shown as 2 to 3, or 2 E slots to 3 BE slots. Reverting to FIG. 3A, a number of G slots 227 and a number of DB slots 223 are assigned (S303) in WRR list 209 by scheduler 207 to meet a G guarantee and a DB guarantee, respectively, i.e. for each, the ratio of the number of assigned slots to the total number of slots in the WRR list 209 is at least equal to the fraction of link bandwidth guaranteed. For example, the G reservation shown in FIG. 2 is 25%, or 3 G slots divided by 12 total slots. The DB reservation of FIG. 2 is approximately 33%, or 4 DB slots divided by 12 total slots.

Referring to FIG. 3A, scheduler 207 initializes (S305) EGQ 231 by setting the number of cells of EG cells 235 to zero. Scheduler 207 activates (S307) G cell detector 237 and EGQ calculator 239, to perform G cell tracking by detecting G cells and adding to EGQ 231 as described above, and subtracting from EGQ 231 as described in detail below. Scheduler 207 initializes pointer 211 and opens (S309) DB queue 201, G+E queue 203, and BE queue 205 to cell traffic.

At S311, pointer 211 advances to the first slot in WRR list 209. Scheduler 207 determines (S313) if the slot is a DB slot 223. If the slot is not a DB slot 223, the process advances to S319. On the other hand, if the slot is a DB slot 223, scheduler 207 checks (S315) if DB queue 201 is empty. If DB queue 201 is empty, the process advances to S337. If DB queue 201 is not empty, the HOL cell of DB queue 201 is served (S317), and the process advances to S337.

At S319, scheduler 207 determines if the slot is a G slot 227. If the slot is not a G slot 227, the process advances to S327. On the other hand, if the slot is a G slot 227, scheduler 207 checks (S321) if EGQ 231 is empty. If EGQ 231 is empty, the process advances to S337. If EGQ 231 is not empty, the HOL cell of G+E queue 203 is served (S323), and tracking continues by virtue of the EGQ 231 being subtracted from (S325) by decrementing EG cells 235 using G slot use signal and EGQ calculator 239 as discussed above, and the process advances to S337.

At S327, scheduler 207 determines if the slot is an E slot 229. If the slot is not an E slot 229, the process advances to S333. On the other hand, if the slot is an E slot 229, scheduler 207 checks (S329) if G+E queue 203 is empty. If G+E queue 203 is empty, the process advances to S337. If G+E queue 203 is not empty, the HOL cell of G+E queue 203 is served (S330), and scheduler 207 again checks (S331) if G+E queue 203 is empty. If G+E queue 203 is empty, the EGQ is reset (S332) by setting EG cells 235 equal to zero, and the process advances to S337. If G+E queue 203 is not empty, the process advances to S337.

At S333, scheduler 207 checks if BE queue 205 is empty. If BE queue 205 is empty, the process advances to S337. If BE queue 205 is not empty, the HOL cell of BE queue 205 is served (S335), and the process advances to S337.

At S337, scheduler 207 determines whether to continue scheduling cells based on some criteria (e.g., an elapse of a predetermined amount of time, the processing of a predetermined number of cells, receipt of a stop command, or the like). If scheduler 207 determines to continue, the process returns to S311, where the pointer advances to the next slot and the process is repeated.

In contrast to a traditional WRR, the present embodiment can maintain a predetermined desired ratio of available bandwidth allocation between E traffic and BE traffic during an interval of time when both queues are active. Even as the DB traffic and the G traffic varies, the ratio of available bandwidth allocation remains constant at the predetermined desired ratio. As an illustrative example, consider the situation in which DB queue 201 is promised access to 20% of link bandwidth and G traffic within the G+E queue 203 is promised access to 30% of link bandwidth (note these reservations are different from those illustrated in FIG. 2). To achieve these guaranteed bandwidth reservations, 20% of the total number of slots are assigned as DB slots 223 and 30% of the total number of slots are assigned as G slots 227. Therefore, 50% of the slots in WRR list 209 are assigned to meet guaranteed bandwidth reservations. For ease of comparison, these are the same bandwidth reservations as the example of a traditional WRR described above in reference to FIG. 10A.

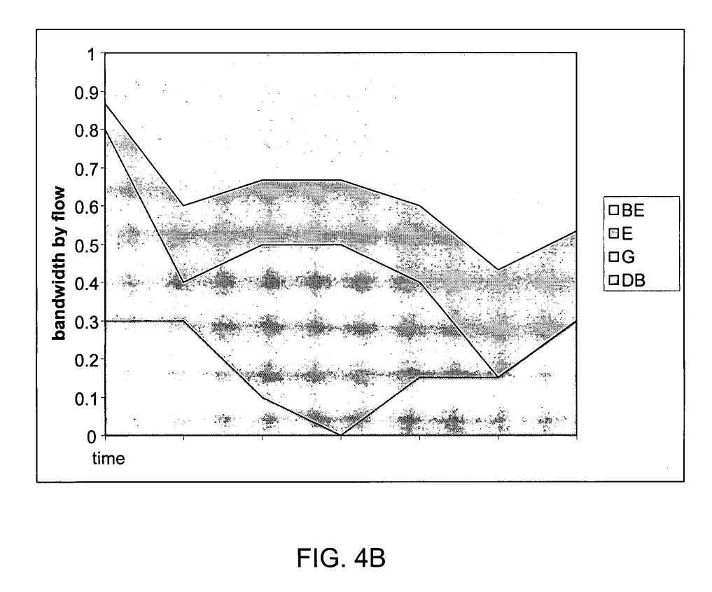

Because the embodiment allows individual weighting of the E flow as well as of the BE flow, a desired ratio can be set by assigning the correct number of E slots 229 and BE slots 225. Specifically, the desired ratio of E available bandwidth allocation to BE available bandwidth allocation is the ratio of the number of assigned E slots 229 to the number of assigned BE slots 225. For example, in the case that the desired ratio is 1:2, approximately 16.7% of the total number of slots are assigned as E slots 229 (approximately ⅓ of the 50% of slots remaining after the DB and G slots are assigned), and approximately 33.3% of the total number of slots are assigned as BE slots 225 (approximately ⅔ of the remaining slots after the DB and G slots are assigned). FIG. 4A illustrates an example of how available bandwidth (the amount of link bandwidth not being consumed by DB traffic and G traffic) is allocated between E and BE traffic as actual DB and G demand varies over time. In FIG. 4A, E traffic receives a constant 33% of available bandwidth (available bandwidth is the total bandwidth shown in the top two bands of FIG. 4A), and BE traffic receives a constant 66% of available bandwidth, or twice the E allocation, which is the desired ratio in this example.

As another example, using guaranteed reservations and actual demand of the guaranteed bandwidth flows different from the case of FIG. 4A, FIG. 4B shows how available bandwidth is allocated to E and BE traffic in the scheduler of the present embodiment in which DB queue 201 is promised access to 30% of link bandwidth (30% of the total number of slots are assigned as DB slots 223) and G traffic within the G+E queue 203 is promised access to 50% of link bandwidth (50% of the total number of slots are assigned as G slots 227). Therefore, 80% of the slots in WRR list 209 are assigned to meet guaranteed bandwidth reservations. For ease of comparison to FIG. 4A, the desired ratio in this example is also 1:2. Therefore, approximately 6.7% of the total number of slots are assigned as E slots 229 (approximately ⅓ of the number of slots remaining after guaranteed bandwidth reservations are met), and approximately 13.3% of the total number of slots are assigned as BE slots 225 (approximately ⅔ of the total number of slots remaining after guaranteed bandwidth reservations are met). FIG. 4B shows that E traffic receives a constant 33% of available bandwidth and BE traffic receives a constant 66% of available bandwidth. Thus, regardless of variation in actual DB and G demand, and regardless of the size of DB and G reservations, the desired ratio is achieved.

Having described the present invention in the context of a WRR scheduler by way of one exemplary embodiment above, another embodiment of the invention will now be described. Specifically, the present invention will now be described in the context of a DRR scheduler by way of the following exemplary embodiment. In particular, the scope of the invention includes scheduling units of data in the form of variable-length packets, as in, for example, a DRR scheduler. In contrast to the above-described embodiment, in which the number of G cells served by E slots balances the number of E cells served by G slots, in the present embodiment, the quantity of E data that is served by G slots balances the quantity of G data served by E slots.

A general description of the present embodiment will now be given, followed by a more detailed description. In this embodiment, a number of slots and a quantum of service credit are assigned to each flow. The quantum of service credit represents a quantity of data to be associated with each slot assigned to the flow. The total service credit of a flow over one round of the DRR scheduler is equal to the product of the number of slots assigned to the flow in the round and the quantum of service credit associated with each slot. The weight of a flow is equal to the total service credit of the flow divided by the total service credit of the system (which is the sum of the total service credits of all of the flows in the system).

When the pointer reaches a slot, the scheduler adds the quantum of service credit associated with the slot's flow to a residual service credit (described below) to provide a service credit for the slot. The slot is then allowed to serve packets. When the slot is used to serve a packet, the packet length is subtracted from the slot's service credit. The slot is allowed to serve packets from the queue associated with the flow until the length of the HOL packet is greater than the remaining service credit for the slot, or until the queue is empty. At this point, if the queue is still active, the remaining service credit is stored as the residual service credit for that flow. On the other hand, if the queue is now empty, the flow's residual service credit is set to zero. In the case of a G slot, it is the Emulated G Queue's status as active or empty that is relevant. Regardless of the queue's state, the pointer is advanced to the next slot in the list. Upon reaching the next slot associated with an active queue, the scheduler calculates the service credit for the slot by adding the quantum of service credit associated with the slot's flow to the flow's residual service credit, and the slot is used to serve packets from the queue associated with that flow until the HOL packet is greater than the remaining service credit, or until the queue is empty.

In this embodiment, instead of tracking cells as in the previous embodiment, the EGQ tracks a quantity of data, for example, the number of bytes that would be stored in a separate G queue if such a queue existed. When a G packet arrives and is enqueued in the G+E queue, the packet length in bytes is added to an EGQ counter. The packet length is also added to a G+E counter tracking the size of the physical G+E queue. When a scheduling opportunity associated with G traffic is used to serve the HOL packet of the G+E queue, the length of the HOL packet served is subtracted from the EGQ counter.

In addition, a service credit and a residual service credit are maintained. In particular, when the scheduler reaches a G slot, an EGQ service credit is set to the minimum of the EGQ counter and the sum of an EGQ residual credit and an EGQ quantum of service credit:
EGQ service credit=min(EGQ counter, residual EGQ credit+EGQ
quantum of service credit). (1)

Then, if the HOL packet of the G+E queue is less than or equal to the EGQ service credit, it is served and the EGQ service credit is reduced by the length of the served packet. As mentioned above, the packet length is also subtracted from the EGQ and G+E counters (as part of tracking), thus reducing the EGQ and G+E counters by the number of bytes served. This process is repeated until either the EGQ is empty (EGQ counter=0) or until the G+E HOL packet is greater than the remaining EGQ service credit. In the former case, the EGQ residual credit is reset to zero. In the latter case, the remaining service credit is stored as the EGQ residual credit until the next time the scheduler reaches a G slot.

Establishing the EGQ counter as an upper bound on the EGQ service credit in equation (1) prevents a scenario in which the EGQ counter becomes negative. If the EGQ service credit is simply set equal to the second term in the min( ) function, and if that term is greater than the EGQ counter, then as packets are served and the EGQ service credit is decremented toward zero, the EGQ counter is also decremented, and could go below zero. For example, this situation could occur if the EGQ counter=100 bytes, the EGQ service credit=1000 bytes, and the HOL packet in the G+E queue is 200 bytes long. If a G slot is used to serve the HOL packet, the EGQ service credit is reduced to 800 bytes, but the EGQ counter is reduced to −100 bytes. The inclusion of the EGQ counter as an upper bound on the EGQ service credit helps avoid such a situation.

When an E packet arrives and is enqueued in the G+E queue, the length in bytes is added to the G+E counter. When the scheduler reaches an E slot, an E service credit for the slot is calculated by adding an E quantum of service credit to an E residual credit. If the HOL packet of the G+E queue is less than or equal to the E service credit, the HOL packet is served and the E service credit and G+E counter are reduced by the number of bytes served. This process is repeated until either the G+E queue is empty, which also implies the EGQ is empty, or until the G+E HOL packet is greater than the remaining E service credit. In the former case, the E residual credit and the EGQ residual credit are both reset to zero. In the latter case, the E residual credit is stored until the next time the scheduler reaches an E slot.

In other words, the EGQ is associated with G traffic, which is associated with G slots and an EGQ quantum of service credit. When the scheduler points to a G slot, the EGQ is active (EGQ counter is greater than zero), the length of the HOL packet of the G+E queue is less than or equal to the EGQ service credit, and current service is completed, a scheduling opportunity associated with G traffic occurs. The scheduler uses the scheduling opportunity associated with G traffic to serve the HOL packet of the G+E queue, which is the physical queue of the G traffic. Thus, scheduling opportunities for the emulated queue EGQ (i.e., scheduling opportunities associated with G traffic) result in service of the HOL packet of the physical queue, G+E queue. The HOL packet of the G+E queue is served regardless of whether the HOL packet is an E packet or a G packet. When a scheduling opportunity associated with G traffic is used to serve the HOL packet, the EGQ counter is decreased by the packet length of the HOL packet as discussed above.

When the scheduler points to an E slot, the G+E queue is active (i.e., the G+E counter is greater than zero), the length of the HOL packet of the G+E queue is less than or equal to the E service credit, and current service is completed, a scheduling opportunity associated with E traffic occurs. The scheduler uses the scheduling opportunity associated with E traffic to serve the HOL packet of the G+E queue, which is the physical queue of the E traffic. The HOL packet of the G+E queue is served regardless of whether the HOL packet is an E packet or a G packet.

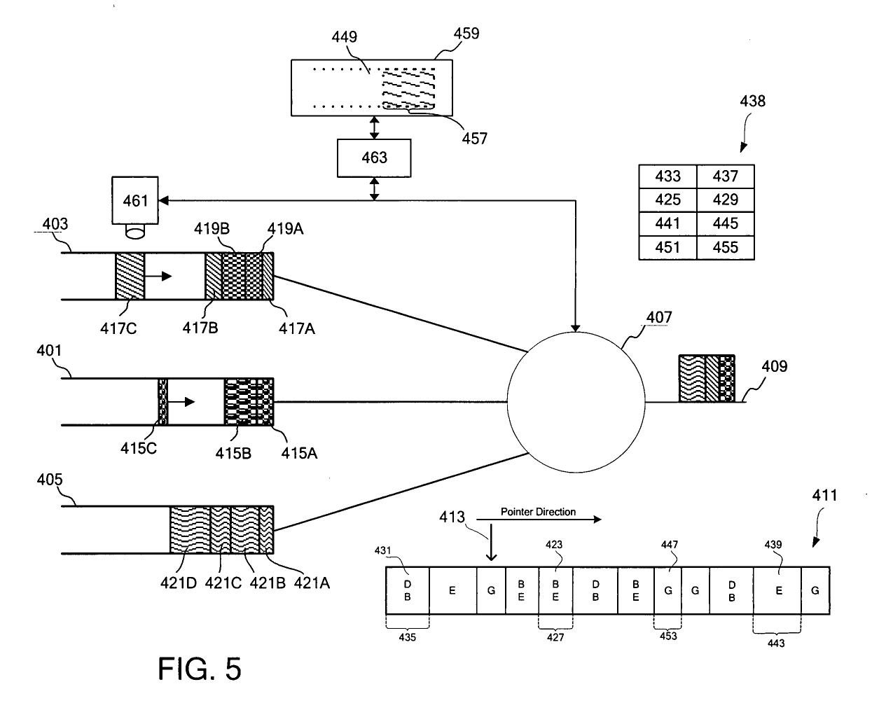

FIG. 5 provides a detailed depiction of the present embodiment. In this embodiment the queues contain variable-length packets, and the scheduler associates a slot in the list not with the service of one cell, but with a quantum of service credit (typically in units of bytes or bits). The queue associated with the slot is allowed to serve as many complete packets as it has credit. Generally, there is some residual credit remaining at the end of service, i.e. a quantity of bandwidth that is smaller than the HOL packet. In that case, the residual credit is remembered as state information for that type of slot. When the scheduler reaches the next slot of that type in the list, the residual credit is added to the normal credit quantum, and again the maximum number (possibly zero) of complete packets is served such that the credit is strictly non-negative. Bandwidth reservations are achieved by assigning different quanta to different flows, or by assigning different numbers of slots to different flows, or by some combination of both. When a queue (either a physical queue or an EGQ) becomes inactive (empty), the residual credit associated with the slots of the queue is reset to zero.

FIG. 5 depicts a DB queue 401, a G+E queue 403, and a BE queue 405 multiplexed by a scheduler 407 onto a link 409 using a DRR list 411 and a pointer 413. Although only one of each type of queue is shown, it is also within the scope of the invention to use more or fewer queues of each type, or other types of queues, depending upon applicable design criteria, as long as at least one queue is a mixed queue. As a DB packet 415C arrives at DB queue 401, DB packet 415C is enqueued sequentially based on arrival time behind earlier arriving DB packets 415A and 415B. The packet in DB queue 401 with the earliest arrival time, DB packet 415A, is at the HOL. Similarly, as a G packet 417C arrives at G+E queue 403, G packet 417C is enqueued sequentially behind earlier arriving G packets 417A and 417B and earlier arriving E packets 419A and 419B. As shown in FIG. 5, G packet 417A is currently the HOL packet of G+E queue 403. Finally, BE queue 405, which currently contains BE packets 421A, 421B, 421C, and 421D, is filled in a corresponding fashion.

Physical queue counters (not shown) track the size of the physical queues. For example, a DB counter tracks the size of DB queue 401, a G+E counter tracks the size of G+E queue 403, and a BE counter tracks the size of BE queue 405.

As shown in FIG. 5, scheduler 407 assigns a number of slots and a quantum of service credit for each flow to reflect the flow's weight. DB slots 431 are associated with the DB flow of traffic in DB queue 401. Each DB slot 431 is associated with a DB Quantum of Service Credit (DB_QSC) 435. The weight of the DB flow equals the total service credit of the DB flow (which is the product of DB_QSC 435 and the number of DB slots 431 assigned in DRR list 411) divided by the total service credit of the system, as described above. During operation, when pointer 413 reaches a DB slot 431, a DB Service Credit (DB_SC) 433 for the slot is calculated as the sum of DB_QSC 435 and a DB Residual Credit (DB_RC) 437. For illustrative purposes, FIG. 5 shows a memory 438 used to store the residual credit and the service credit of each queue. However, memory 438 represents only a part of the data store of the present embodiment, which can include a single memory device or any suitable combination of memory devices. To use a DB slot 431, scheduler 407 serves HOL packets of DB queue 401, and reduces DB_SC 433 and the DB counter by the packet length of each HOL packet served. Scheduler 407 continues to use the slot until either the queue is empty or the HOL packet length is greater than the remaining value of DB_SC 433. If the DB queue is not empty (DB counter>0), the remaining value of DB_SC 433 is stored as DB_RC 437, and pointer 413 advances to the next slot. When pointer 413 reaches another DB slot 431, DB_RC 437 is added to DB_QSC 435 to obtain the DB_SC 433 for that slot.

Similarly, BE slots 423 are associated with BE traffic in the BE queue 405, and each BE slot 423 is associated with a BE Service Credit (BE_SC) 425, a BE Quantum of Service Credit (BE_QSC) 427, and a BE Residual Credit (BE_RC) 429. The weight of the BE flow equals the total service credit of the BE flow (which is the product of BE_QSC 427 and the number of BE slots 423 assigned in DRR list 411) divided by the total service credit of the system, as described above. Scheduler 407 utilizes the BE slots 423 to serve packets in BE queue 405 in the same fashion as the DB slots 431 are used to serve packets in DB queue 401.

E slots 439 are associated with E traffic in the G+E queue 403. Each E slot 439 is associated with an E Service Credit (E_SC) 441, an E Quantum of Service Credit (E_QSC) 443, and an E Residual Credit (E_RC) 445. The weight of the E flow equals the total service credit of the E flow (which is the product of E_QSC 443 and the number of E slots 439 assigned in DRR list 411) divided by the total service credit of the system, as described above. Scheduler 407 utilizes E slots 439 to serve packets of G+E queue 403, regardless of whether the packets are E packets or G packets, until the HOL packet of G+E queue 403 is greater than the remaining service credit of the E slot 439 or until the G+E queue is empty, in the same manner as above.

Each G slot 447 is associated with G traffic in G+E queue 403, and with an Emulated G Queue (EGQ) 449. Each G slot 447 is associated with an Emulated G Service Credit (EG_SC) 451, an Emulated G Quantum of Service Credit (EG_QSC) 453, and an Emulated G Residual Credit (EG_RC) 455. The weight of the G flow equals the total service credit of the G flow (which is the product of EG_QSC 453 and the number of G slots 447 assigned in DRR list 411) divided by the total service credit of the system. To utilize a G slot 447, scheduler 407 sets EG_SC 451 equal to the minimum of an Emulated G (EG) counter 457 and the sum of EG_QSC 453 and EG_RC 455. Scheduler 407 utilizes a G slot 447 by continuing to serve the HOL packets of G+E queue 403 until either EGQ 449 is empty or the HOL packet length is greater than the remaining value of EG_SC 451. Thus, a G slot 447 can serve G packets and/or E packets, and an E slot 439 can serve G packets and/or E packets.

EGQ 449 is implemented as a data store in a computer-readable memory 459. EGQ 449 maintains state information regarding G packets in the form of EG counter 457. A G packet detector 461 detects a G packet entering G+E queue 403, such as G packet 417C, and consequently sends a G packet detection signal (not shown) to an EGQ calculator 463. The G packet detection signal includes information of the packet length of the detected G packet. Upon receipt of the G packet detection signal, EGQ calculator 463 adds to EGQ 449 by increasing EG counter 457 by the packet length of the detected G packet. When a G slot 447 is used to serve an HOL packet (i.e., when a scheduling opportunity associated with G traffic is used to serve the HOL packet), scheduler 407 sends a G slot use signal (not shown) to EGQ calculator 463. The G slot use signal includes information of the packet length of the served HOL packet. Upon receipt of the G slot use signal, EGQ calculator 463 subtracts from EGQ 449 by decreasing EG counter 457 by the packet length of the HOL packet served. EG_SC 451 and the G+E counter are also decremented in this case.

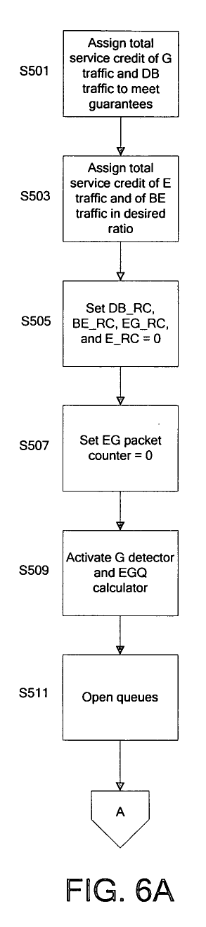

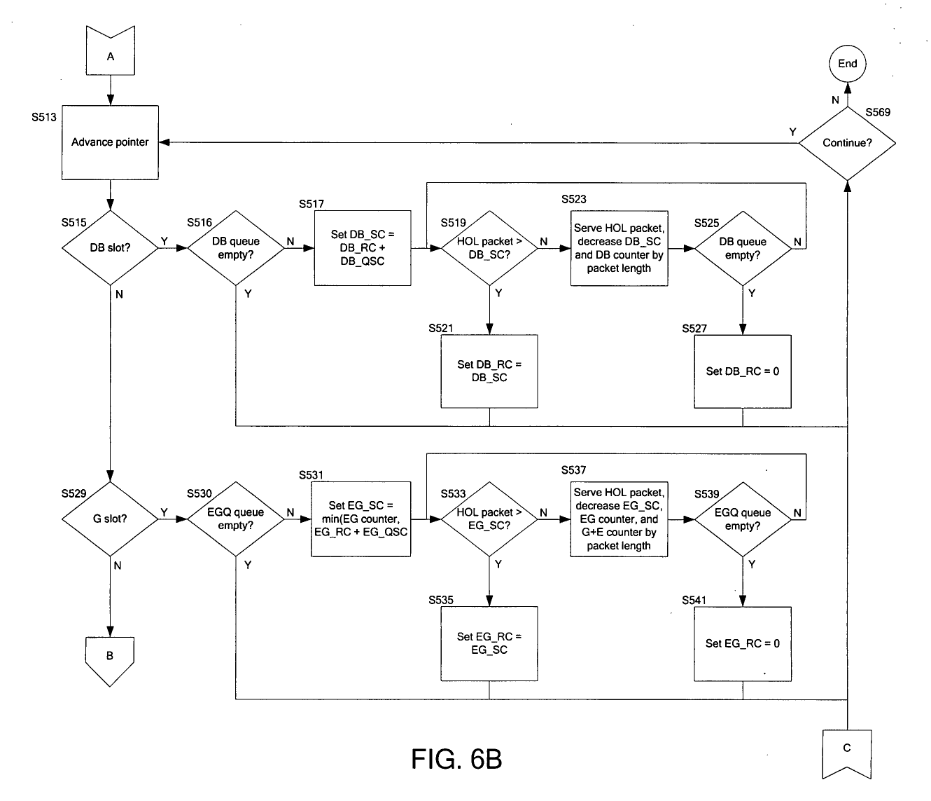

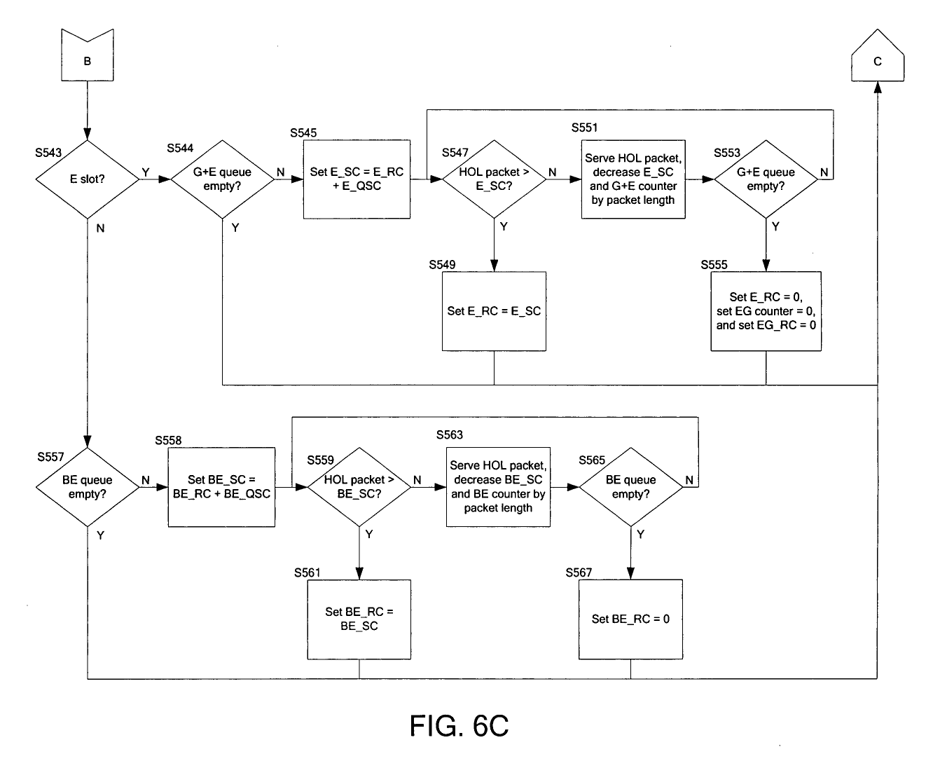

Referring now to FIG. 6A through FIG. 6C, and FIG. 5, a method of scheduling packets in accordance with the present embodiment of the invention will now be described in more detail. Turning to FIG. 6A, scheduler 407 assigns a service credit to each flow to reflect the flow's weight. In particular scheduler 407 assigns (S501) a total G service credit and a total DB service credit in a desired proportion to the total service credit to be assigned among all flows in the system, such that the respective G and DB guarantees are met. Likewise, scheduler 407 assigns (S503) a total E service credit and a total BE service credit such that the desired ratio of available bandwidth allocation between E traffic and BE traffic is met. In the present embodiment, the total service credit of a flow of traffic is the product of the number of slots and the quantum of service credit assigned to the flow, as described above. The weight of a flow of traffic is equal to the total service credit assigned to the flow divided by the total service credit of all of the flows in the system.

Therefore, for example, the total service credit of the G flow is assigned such that the total service credit of the G flow divided by the total service credit of all of the flows in the system (the G flow weight) is at least equal to the portion of bandwidth on link 409 guaranteed to the G flow. The total service credit of the DB flow is assigned in the same fashion to meet the DB bandwidth guarantee. Thus, scheduler 407 weights the G flow and the DB flow by assigning the number of G slots 447, the number of DB slots 431, EG_QSC 453, and DB_QSC 435 to satisfy the predetermined G guarantee and DB guarantee. Likewise, scheduler 407 weights the E flow and the BE flow by assigning the number of E slots 439, the number of BE slots 423, E_QSC 443, and BE_QSC 427 to satisfy the predetermined desired ratio of available bandwidth allocation between the E flow and the BE flow. Thus, a total service credit of the E flow and a total service credit of the BE flow are assigned in the predetermined desired ratio.

Scheduler 407 sets (S505) each of DB_RC 437, BE_RC 429, EG_RC 455, and E_RC 445 equal to zero.

Scheduler 407 initializes (S507) EGQ 449 by setting EG counter 457 to zero. Scheduler 407 initiates tracking by activating (S509) G packet detector 461 and EGQ calculator 463, which then begin detecting G packets and adding to EG counter 457 as described above, and subtracting from EG counter 457 as described above and in more detail below. Scheduler 407 opens (S511) DB queue 401, G+E queue 403, and BE queue 405 to packet traffic.

Now referring to FIG. 6B, at S513 pointer 413 advances to the first slot in DRR list 411. Scheduler 407 determines (S515) if the slot is a DB slot 431. If the slot is not a DB slot 431, the process advances to S529. On the other hand, if the slot is a DB slot 431, scheduler 407 checks (S516) if DB queue 401 is empty. If DB queue 401 is empty, the process advances to S569. However, if DB queue 401 is not empty, scheduler 407 sets (S517) DB_SC 433 equal to the sum of DB_RC 437 and DB_QSC 435. Scheduler 407 then determines (S519) whether the packet length of the HOL packet of DB queue 401 is greater than DB_SC 433. If the packet length is greater than DB_SC 433, scheduler 407 sets (S521) DB_RC 437 equal to DB_SC 433, and the process advances to S569. If the packet length is not greater than DB_SC 433, scheduler 407 serves the HOL packet and decreases DB_SC 433 and the DB counter by the length of the packet served at S523, and the process advances to S525. At S525, scheduler 407 again checks if DB queue 401 is empty. If DB queue 401 is empty, scheduler 407 sets (S527) DB_RC 437 equal to zero, and the process advances to S569. If DB queue 401 is not empty, the process returns to S519.

At S529, scheduler 407 determines if the slot is a G slot 447. If the slot is not a G slot 447, the process advances to S543. On the other hand, if the slot is a G slot 447, scheduler 407 checks (S530) if EGQ 449 is empty (EG counter 457=0). If EGQ 449 is empty, the process advances to S569. However, if EGQ 449 is not empty, scheduler 407 sets (S531) EG_SC 451 equal to the minimum of EG counter 457 and the sum of EG_QSC 453 and EG_RC 455. Scheduler 407 then determines (S533) whether the packet length of the HOL packet of G+E queue 403 is greater than EG_SC 451. If the packet length is greater than EG_SC 451, scheduler 407 sets (S535) EG_RC 455 equal to EG_SC 451, and the process advances to S569. If the packet length is not greater than EG_SC 451, scheduler 407 serves the HOL packet and subtracts the length of the packet served from EG_SC 451, EG counter 457, and the G+E counter at S537, as part of continued tracking, and the process advances to S539. At S539, scheduler 407 again checks if EGQ 449 is empty. If EGQ 449 is empty, scheduler 407 sets (S541) EG_RC 455 equal to zero, and the process advances to S569. If EGQ 449 is not empty, the process returns to S533.

At S543, scheduler 407 determines if the slot is an E slot 439. If the slot is not an E slot 439, the process advances to S557. On the other hand, if the slot is an E slot 439, scheduler 407 checks (S544) if G+E queue 403 is empty. If G+E queue 403 is empty, the process advances to S569. However, if G+E queue 403 is not empty, scheduler 407 sets (S545) E_SC 441 equal to the sum of E_RC 445 and E_QSC 443. Scheduler 407 then determines (S547) whether the packet length of the HOL packet of G+E queue 403 is greater than E_SC 441. If the packet length is greater than E_SC 441, scheduler 407 sets (S549) E_RC 445 equal to E_SC 441, and the process advances to S569. If the packet length is not greater than E_SC 441, scheduler 407 serves the HOL packet and decreases E_SC 441 and the G+E counter by the length of the packet served at S551, and the process advances to S553. At S533, scheduler 407 again checks if G+E queue 403 is empty. If G+E queue 403 is empty, scheduler 407 sets E_RC 445 equal to zero, and resets EGQ 449 by setting EG counter 457 and EG_RC 455 equal to zero at S555, and the process advances to S569. If G+E queue 403 is not empty, the process returns to S547.

At S557, scheduler 407 checks if BE queue 405 is empty. If BE queue 405 is empty, the process advances to S569. However, if BE queue 405 is not empty, scheduler 407 sets BE_SC 425 equal to the sum of BE_RC 429 and BE_QSC 427. Scheduler 407 then determines (S559) whether the packet length of the HOL packet of BE queue 405 is greater than BE_SC 425. If the packet length is greater than BE_SC 425, scheduler 407 sets (S561) BE_RC 429 equal to BE_SC 425, and the process advances to S569. If the packet length is not greater than BE_SC 425, scheduler 407 serves the HOL packet and decreases BE_SC 425 and the BE counter by the length of the packet served at S563, and the process advances to S565. At S565, scheduler 407 again checks if BE queue 405 is empty. If BE queue 405 is empty, scheduler 407 sets (S567) BE_RC 429 equal to zero, and the process advances to S569. If BE queue 405 is not empty, the process returns to S559.

At S569, scheduler 407 determines whether to continue scheduling cells based on some criteria (e.g., a lapse of a predetermined amount of time, processing of a predetermined amount of traffic, receipt of a stop command, or the like). If scheduler 407 determines to continue, the process returns to S513, where the pointer advances to the next slot and the process is repeated.

The present embodiment can provide a constant desired ratio of E traffic to BE traffic as a result of the foregoing procedure. FIGS. 4A and 4B are representative of example results, assuming similar guaranteed bandwidth allocation and actual demand as described in the prior embodiment.

It is also within the scope of the invention to use other methods of scheduling, for example methods based on one of the many variants of WFQ. Another embodiment of the present invention is applied to an SFQ-type scheduler, as will now be described.

In the present embodiment, each flow of data again is assigned a weight. In the previously-described embodiments the weight is manifested in a number of slots or in a number of slots and a quantum of service credit per slot. By contrast, in the present embodiment the weight is manifested in a mathematical formula that is used to calculate an index, the “start time,” that is sorted to determine scheduling order. When a packet arrives its “start time” (ST) is computed as the maximum of the “finish time” (FT) of the preceding packet from the same flow and the ST of the packet currently in service. Once the ST of a packet is computed, the FT of the packet is computed by adding the ST of the packet to the length of the packet divided by the assigned weight (Wₖ) of the packet's flow. In other words, assume packet j of flow k arrives while packet x is in service (x and j need not be from the same flow). The start time of packet j is:
ST(kj)=max(FT(k,j−1),ST(x)).
If flow k has weight wₖ and packet j has length L(kj), then the finish time is:
FT(k,j)=ST(kj)+L(kj)/w_{k.}

When one packet completes service, the scheduler begins serving the queue associated with the minimum start time, in particular it serves the HOL packet of that queue. Thus, in the present embodiment, the start time of a packet is a scheduling index, which is calculated in part based on the weight of the packet's flow.

In general, a scheduling index is a value associated with each packet, the value being used by the scheduler to determine service. Specifically, when the scheduler determines a scheduling opportunity for queue X, the determination is based at least in part on the scheduling index of a packet associated with queue X.

In the previously-described embodiments, the scheduling opportunities of the queues have a relatively static order, e.g., they are determined as the scheduler advances through a predetermined list of slots. In contrast, in the present embodiment the scheduling opportunities of the queues are determined more dynamically, based in part on scheduling index values of packets that are calculated during the operation of the scheduler.

An EGQ tracks G packet information about the G packets. When a G packet arrives and is enqueued in the G+E queue, its start time (i.e., scheduling index value) is determined based partly on the G packet flow, i.e. the “FT(k,j−1)” term above refers to the most recent preceding G packet, not to any E packets that may have arrived in the G+E queue. A scheduling opportunity for the EGQ occurs when a G packet start time is the minimum of all of the start times in the queuing system, which results in the G+E queue being selected for service. Similarly, when an E packet arrives and is enqueued in the G+E queue, its start time is determined based on the E packet flow. However, when either a G packet or an E packet is identified by the scheduler as having the minimum start time (because the start time is smaller than any other packet in the system), the HOL packet of the G+E queue is served. Analogously to previous embodiments, it is possible that the scheduler will use a G packet scheduling opportunity (in this case, a G packet start time) to serve an E packet, and vice versa.

The start times and finish times of the G packets and E packets are recorded in the EGQ, which is implemented as a data store in a computer-readable memory, as part of tracking in this embodiment. For example, an ordered list of the start times of the G packets is maintained in the EGQ, and the finish time of each G packet is stored along with its start time as a data record in the EGQ. When a G packet is enqueued, its start time is added to the end of the G start time list. Similarly, an ordered list of start times (and finish times) of the E packets is maintained. When a G packet or an E packet has the minimum start time of all packets in the system, the minimum start time and associated finish time are subtracted from the appropriate start time list by removing the start/finish time pair from the list, and the HOL packet of the G+E queue is served. It is possible, however, that the packet served is not the one that had the minimum start time, i.e. a disassociation can occur between the start time list and the G+E queue. When the packet being served is not the same as the packet with the minimum start time, the latter is used to calculate the start time of an arriving packet. In other words, the packet x, whose start time ST(x) is used in the preceding equation, is always the packet that has the minimum start time in one of the start time lists, even if a different packet has been chosen for transmission.

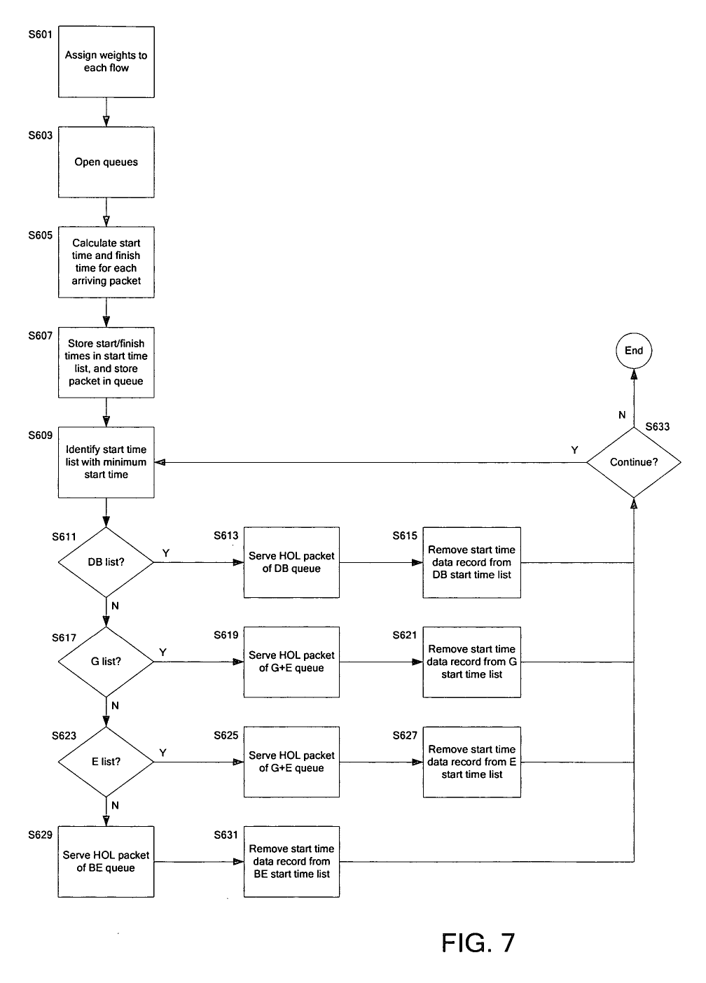

FIG. 7 depicts a process flowchart of one method of scheduling according to the present embodiment. At S601, the scheduler assigns weights wk to each flow of E and BE traffic, based on a desired ratio of available bandwidth allocation between E and BE traffic, and assigns weights Wk to each flow of DB and G traffic, based on bandwidth guarantees for those respective flows of DB and G traffic. The queues are opened (S603). For each arriving packet that is enqueued, the start time and finish time are calculated (S605) and added to (S607) the corresponding start time list as a data record (as part of tracking), such that the list is sorted in ascending order of start times. Therefore, the search for the minimum start time in the system is just a search among the first entry of every start time list. The packet itself is also stored (S607) in the appropriate queue. The start time list containing the minimum start time is identified (S609). If the identified start time list is the DB start time list (S611), the HOL packet of the DB queue is served (S613), the minimum start time data record (i.e. the start time, finish time pair) is removed (S615) from the DB start time list, and the process advances to S633. If the identified start time list is the G start time list (S617), the HOL packet of the G+E queue is served (S619), the scheduler subtracts (S621) the minimum start time data record from the G start time list by removing the data record from the list, and the process advances to S633. If the identified start time list is the E start time list (S623), the HOL packet of the G+E queue is served (S625), the minimum start time data record is removed (S627) from the E start time list, and the process advances to S633. Else, the HOL packet of the BE queue is served (S629), the minimum start time data record is removed (S631) from the BE start time list, and the process advances to S633 where the process decides whether to continue based on predetermined criteria.

In other words, the EGQ is associated with G traffic, which is associated with G start times. When the scheduler determines the G start time list holds the minimum start time data record, and current service is completed, a scheduling opportunity associated with G traffic occurs. The scheduler uses the scheduling opportunity associated with G traffic to serve the HOL packet of the G+E queue, which is the physical queue of the G traffic. Thus, scheduling opportunities for the emulated queue EGQ (i.e., scheduling opportunities associated with G traffic) result in service of the HOL packet of the physical queue, G+E queue. The HOL packet of the G+E queue is served regardless of whether the HOL packet is an E packet or a G packet. When a scheduling opportunity associated with G traffic is used to serve the HOL packet, the scheduler subtracts the minimum start time data record from the EGQ as discussed above.

When the scheduler determines the E start time list holds the minimum start time data record, and current service is completed, a scheduling opportunity associated with E traffic occurs. The scheduler uses the scheduling opportunity associated with E traffic to serve the HOL packet of the G+E queue, which is the physical queue of the E traffic. The HOL packet of the G+E queue is served regardless of whether the HOL packet is an E packet or a G packet. When a scheduling opportunity associated with E traffic is used to serve the HOL packet, the scheduler subtracts the minimum start time data record from the E start time list as discussed above.

The present embodiment can provide a constant desired ratio of E traffic to BE traffic as a result of the foregoing procedure. FIGS. 4A and 4B are representative of example results, assuming similar guaranteed bandwidth allocations and actual demand as described for the previous embodiments.

In one variation of the present embodiment, only one start time list for all G and E packets is maintained. When a new packet is enqueued, whether G or E, its start time is computed as before and is inserted in the start time list at the appropriate point so the list remains sorted from smallest to largest start time. The corresponding finish time is inserted with the start time in a data record as usual.

The invention can also be implemented in a case where arriving packets in the G+E class are not explicitly marked as belonging to the G flow or to the E flow. In other words, the invention can be utilized even if policing and marking are not performed upstream of the queue/scheduler, either on the aggregate G+E class or individually on constituent G+E flows.

For example, in one embodiment of the invention, the scheduler functions as an implicit policer, that may be employed to perform a policing function in any embodiment described above. If the scheduler is configured to provide the G+E class with at least the guaranteed G bandwidth, then by definition any packet discarded is part of the excess E flow. When the queue is allowed to use bandwidth above the minimum, either because it is configured to provide more than the G guarantee, or because some other queues use less than they are allowed, or both, the “implicit policer” becomes “loose” in that it allows some excess traffic (i.e., unmarked E packets) to pass through. If a policer is used, the policer can operate in conjunction with, for example, the G cell or G packet detector described above, or can replace the G cell or G packet detector if configured to additionally provide the function thereof.

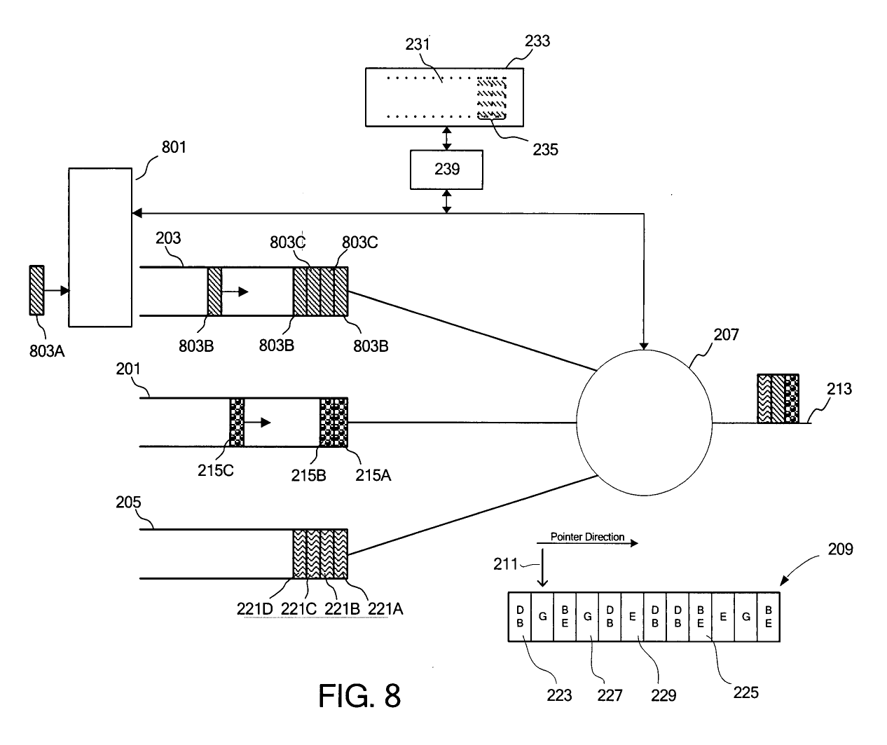

A policer can be added to any of the embodiments described herein. The policing outcome is used to decide when to update the state of the Emulated G Queue and when to update any state information associated with E traffic. For example, FIG. 8 depicts one embodiment of the present invention in which a Leaky Bucket policer 801 has been added to the embodiment illustrated in FIG. 2 (and the component 237 removed). Leaky Bucket policer 801 may be provided to determine when an arriving packet should be treated as a G packet or E packet. For example, unmarked packets, such as unmarked packet 803A, arrive at Leaky Bucket policer 801 and are classified as G packets 803B or E packets 803C. Note that Leaky Bucket policer 801 does not necessarily explicitly mark packets as G or E; therefore, FIG. 8 depicts the packets in G+E queue 203 with the same hatching (i.e., unmarked), even though they have been classified as G packets 803B or E packets 803C. The policing outcome is used to decide when to update the state of EGQ 231. Thus, when a packet is regarded as a G packet by the Leaky Bucket policer and passed into G+E queue 203, Leaky Bucket policer 801 sends the policing information that indicates that the arriving packet is to be considered a G packet to EGQ calculator 239 to update EGQ 231 accordingly. Note that in this embodiment, Leaky Bucket policer 801 is configured to perform the additional function of sending a G cell detection signal (not shown) to EGQ calculator 239. Therefore, Leaky Bucket policer 801 replaces the G cell detector in this embodiment. However, in another embodiment, the policing information is sent from Leaky Bucket policer 801 to the G cell detector, which then sends a G cell detection signal to EGQ calculator 239. With the exception of providing policing information to allow the scheduler 207 to determine how to treat an arriving packet, the addition of a policer, or equivalent system, does not effect the operation of the scheduler.

It is also within the scope of the invention to use queuing and scheduling on any granularity. In particular, there may be several (perhaps very many) separately queued G+E flows and similarly several separately queued BE flows. Each G+E flow has separate G and E weights. In this case there are many G+E flows, each with its own G+E flow queue, while the G and E portions of that flow share a physical queue. An emulated G queue is used to separately model the G portion of the flow, as in the emulated G queue concept for an aggregate G+E class queue described above.

In addition, those skilled in the art will appreciate that the embodiments described herein, and other embodiments of the present invention, are able to operate (albeit at a possibly reduced functionality) even in the case that no minimum guarantee is associated with the mixed queue(s). For example, if no “G traffic” weight is assigned for a mixed queue (e.g., zero G slots assigned) the embodiments are still able to operate, but will schedule traffic in the mixed queue (whether E traffic or G traffic) as if the mixed queue were essentially a BE queue.

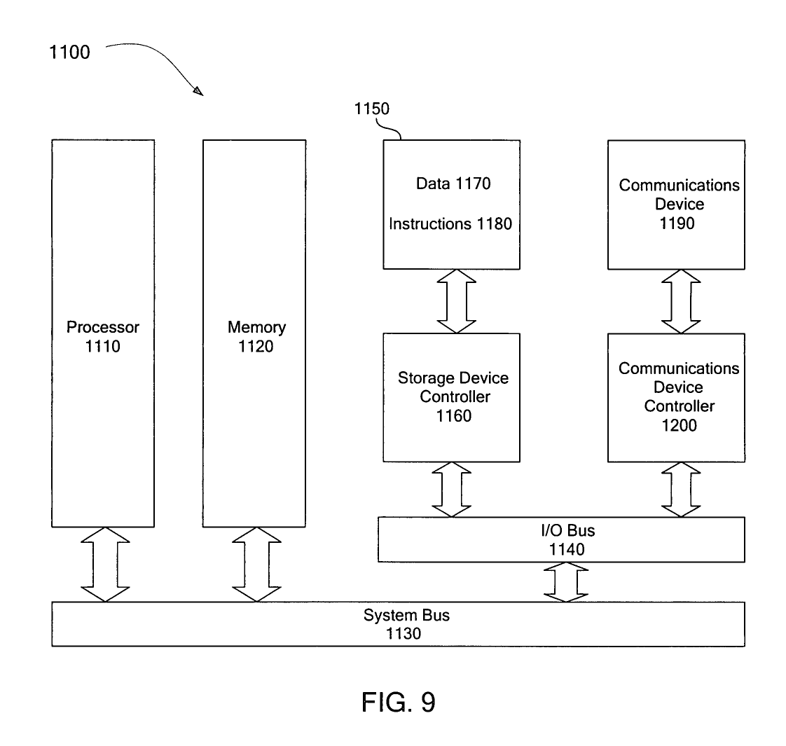

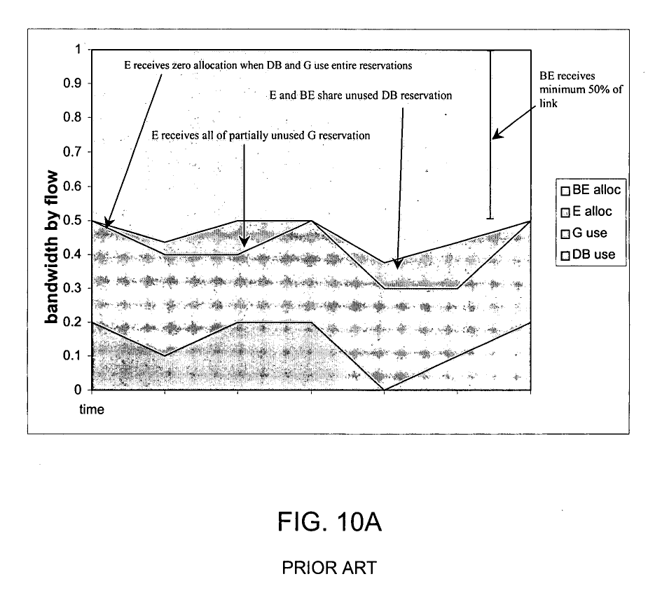

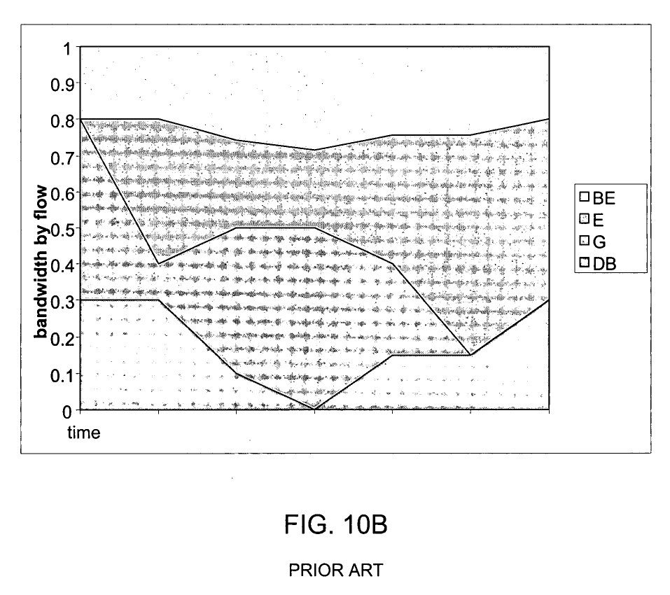

The present invention can be implemented as computer-executable program instructions stored on a computer-readable medium. For example, FIG. 9 is an architecture diagram for a data processing system 1100, such as a general purpose computing machine shown in FIG. 1 as 101, suitable for hosting a scheduler in accordance with an exemplary embodiment of the present invention.

A data processing system 1100 includes a processor 1110 coupled to a memory 1120 via system bus 1130. The processor is also coupled to external Input/Output (I/O) devices (not shown) via the system bus 1130 and an I/O bus 1140. A storage device 1150 having a computer-readable medium is coupled to the processor 1110 via a storage device controller 1160 and the I/O bus 1140 and the system bus 1130. The storage device 1150 is used by the processor 1110 and controller 1160 to store and read/write data 1170 and program instructions 1180 used to implement the features of a scheduler as described above. For example, those instructions 1180 can perform any of the methods described above and shown in FIGS. 3A to 3B, 6A to 6C, and 7.

The processor 1110 may be further coupled to a communications device 1190 via a communications device controller 1200 coupled to the I/O bus 1140. The processor 1110 uses the communications device 1190 to communicate with a network (not shown in FIG. 8) transmitting multiple flows of data as previously described.

In operation, the processor 1110 loads the program instructions 1180 from the storage device 1150 into the memory 1120. The processor 1110 then executes the loaded program instructions 1180 to schedule data packets as described above, and thus operates under the control of the instructions 1180 to perform the method(s) of this invention.

The invention can be applied in other scheduling scenarios, for example, when a DB queue is assigned more slots than required for the bandwidth guarantee so that DB traffic experiences less delay in being served. The more slots the queue has, the more frequently the queue is consulted to see if it has traffic to send. When assigning extra slots to a DB queue, a policer (such as a Leaky Bucket policer described above) can be used to limit the traffic entering the DB queue to a quantity no higher than the bandwidth guarantee, which means that not all of the DB slots will be utilized. As the number of slots assigned to the DB queue increases, the priority given to the DB queue increases over the priority given to the G+E and BE queues, which means that the DB queue is consulted with increasing frequency. In addition, a “strict priority” scheduler, one that serves the DB queue whenever a scheduling opportunity arises and the DB queue is not empty, can be implemented by applying logic to the scheduling process. These and other methods of scheduling the DB queue can be implemented with the invention, for example, using strict priority for DB and WRR between G+E and BE.

While various portions of the above-described embodiments refer to distinguishing cells or packets, such as with a policer, it is understood that that this can be accomplished with any of a number of known techniques for classifying cells or packets.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed is:

1. A method of data packet scheduling in a system having a plurality of queues including a mixed queue, the mixed queue having mixed traffic including first traffic associated with a bandwidth guarantee and second traffic associated with a best effort expectation of access to available bandwidth, the method comprising:
assigning a first weight for the first traffic and a second weight for the second traffic;
tracking first information about the first traffic; and
serving the mixed traffic based on the first information such that the first traffic is provided the bandwidth guarantee and the second traffic is served in proportion to the second weight.

2. The method of claim 1, wherein the tracking emulates separate queuing of the first traffic.

3. The method of claim 1, wherein the serving includes serving the mixed traffic when a scheduling opportunity associated with the first traffic occurs, and the proportion of scheduling opportunities associated with the first traffic is based on the first information and the first weight.

4. The method of claim 3, wherein the first traffic includes first packets associated with a first packet value, and the tracking includes at least one of adding the first packet value to the first information when a first packet is enqueued in the mixed queue and subtracting the first packet value from the first information when a scheduling opportunity associated with the first traffic is used to serve the mixed traffic.

5. The method of claim 4, wherein the serving includes comparing the first information with a scheduling criterion and prohibiting a scheduling opportunity associated with the first traffic based on a result of the comparison.

6. The method of claim 5, wherein the assigning a first weight includes assigning a number of first slots, the first information is a counter, the adding includes incrementing the counter, and the subtracting includes decrementing the counter.

7. The method of claim 6, wherein a scheduling opportunity associated with the first traffic occurs when at least a first slot is selected and the counter is non-zero, and wherein the prohibiting includes skipping a first slot when the counter is zero.

8. The method of claim 5, wherein the assigning a first weight includes assigning a number of first slots and a first quantum of service credit, the first packet value is packet length, the first information is a counter, the adding includes increasing the counter by the packet length of a first packet enqueued in the mixed queue, and the subtracting includes decreasing the counter by a packet length of a packet served from the mixed traffic.

9. The method of claim 6, wherein a scheduling opportunity associated with the first traffic occurs when at least a first slot is selected and a packet length of a head-of-line packet of the mixed queue is less than or equal to the counter, and wherein the prohibiting includes selecting a next slot when the counter is less than the packet length of the head-of-line packet of the mixed queue.

10. The method of claim 5, wherein the assigning a first weight includes assigning a first weight value, the first packet value is packet time, the first information is a packet time list, the adding includes appending the packet time of a first packet enqueued in the mixed queue to the packet time list, and the subtracting includes removing the packet time from the packet time list when the packet time is used to serve a packet from the mixed queue.

11. The method of claim 6, wherein a scheduling opportunity associated with the first traffic occurs when at least the packet time list contains a minimum packet time, and wherein the prohibiting includes selecting a different packet time list when the packet time list does not contain the minimum packet time.

12. The method of claim 11, further comprising:
tracking packet times of the second traffic.

13. The method of claim 12, wherein the packet times of the first traffic and the packet times of the second traffic are recorded in the same list.

14. The method of claim 12, wherein the packet times of the first traffic and the packet times of the second traffic are recorded in different lists.

15. The method of claim 12, wherein the packet times are start times, the start time of a first packet is based on the greater of a finish time of a preceding first packet and the start time of a packet currently being served, and the finish time of the preceding first packet is based on the start time of the preceding first packet, a packet length of the preceding first packet, and the first weight, and the start time of a second packet is based on the greater of the finish time of a preceding second packet and the start time of the packet currently being served, and the finish time of the preceding second packet is based on the start time of the preceding second packet, the packet length of the preceding second packet, and the second weight.

16. The method of claim 1, wherein the plurality of queues includes an additional queue having at least third traffic associated with a best effort expectation of access to available bandwidth, the method further comprising:
assigning a third weight for the third traffic,
wherein a ratio of the second weight to the third weight is in a desired ratio of allocation of available bandwidth between the second traffic and the third traffic.

17. The method of claim 1, further comprising:
classifying traffic entering the mixed queue as either first traffic or second traffic.

18. An apparatus for scheduling data packets in a system having a plurality of queues including a mixed queue, the mixed queue having mixed traffic including at least first traffic associated with a bandwidth guarantee and second traffic associated with a best effort expectation of access to available bandwidth, the apparatus comprising:
a computer-readable program memory that stores computer-executable program instructions executable to schedule data packets; and
a processor coupled to the computer-readable program memory, the processor operating under the control of the computer-executable program instructions to assign a first weight for the first traffic and a second weight for the second traffic, track first information about the first traffic, and serve the mixed traffic based on the first information such that the first traffic is provided the guaranteed bandwidth and the second traffic is served in proportion to the second weight.

19. The apparatus of claim 18, wherein the processor assigns a first weight by assigning a number of first slots, tracks first information by incrementing a counter when a first packet is enqueued in the mixed queue and by decrementing the counter when a first slot is used to serve the mixed traffic, and serves by serving the mixed traffic when at least a first slot is selected and the counter is non-zero and by skipping the first slot when the counter is zero.

20. The apparatus of claim 18, wherein the processor assigns a first weight by assigning a number of first slots and a first quantum of service credit, tracks first information by increasing a counter by a packet length of a first packet enqueued in the mixed queue and by decreasing the counter by a packet length of a head-of-line packet served from the mixed traffic when a first slot is used to serve the head-of-line packet, and serves by serving the mixed traffic when at least a first slot is selected and the packet length of the head-of-line packet is less than or equal to the counter and by selecting a next slot when the counter is less than the packet length of the head-of-line packet.

21. The apparatus of claim 18, wherein the processor assigns a first weight by assigning a first weight value, tracks first information by appending a packet time of a first packet enqueued in the mixed queue to a packet time list and by removing the packet time from the packet time list when the packet time is used to serve a packet from the mixed queue, and serves by serving the mixed traffic when at least the packet time list contains a minimum packet time and by selecting a different packet time list when the packet time list does not contain the minimum packet time.

22. Computer-executable program instructions stored on computer-readable medium, the computer-executable program instructions for scheduling data packets in a system having a plurality of queues including a mixed queue, the mixed queue having at least first traffic associated with a bandwidth guarantee and second traffic associated with a best effort expectation of access to available bandwidth, the computer-executable program instructions executable to perform the method of:
assigning a first weight for the first traffic and a second weight for the second traffic;
tracking first information about the first traffic; and
serving the mixed traffic based on the first information such that the first traffic is provided the guaranteed bandwidth and the second traffic is served in proportion to the second weight.

23. The computer-executable instructions of claim 22, wherein the assigning a first weight includes assigning a number of first slots, the tracking of first information includes incrementing a counter when a first packet is enqueued in the mixed queue and decrementing the counter when a first slot is used to serve the mixed traffic, and the serving includes serving the mixed traffic when at least a first slot is selected and the counter is non-zero and skipping the first slot when the counter is zero.

24. The computer-executable instructions of claim 22, wherein the assigning a first weight includes assigning a number of first slots and a first quantum of service credit, the tracking of first information includes increasing a counter by a packet length of a first packet enqueued in the mixed queue and decreasing the counter by a packet length of a head-of-line packet served from the mixed traffic when a first slot is used to serve the head-of-line packet, and the serving includes serving the mixed traffic when at least a first slot is selected and the packet length of the head-of-line packet is less than or equal to the counter and selecting a next slot when the counter is less than the packet length of the head-of-line packet.

25. The computer-executable instructions of claim 22, wherein the assigning a first weight includes assigning a first weight value, the tracking of first information includes appending a packet time of a first packet enqueued in the mixed queue to a packet time list and removing the packet time from the packet time list when the packet time is used to serve a packet from the mixed queue, and the serving includes serving the mixed traffic when at least the packet time list contains a minimum packet time and selecting a different packet time list when. the packet time list does not contain the minimum packet time.
